(19) United States
(12) Patent Application Publication
(10) Pub. No.: US 2011/0029971 A1
(43) Pub. Date: Feb. 3, 2011

(54) INFORMATION PROCESSING APPARATUS, IMAGE PROCESSING METHOD AND COMPUTER PROGRAM

(75) Inventors: Koichi YAMASAKI, Kawasaki (JP); Zhaogong Guo, Kawasaki (JP); Ryuichi Matsukura, Kawasaki (JP); Takashi Ohno, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/846,019

(22) Filed: Jul. 29, 2010

(30) Foreign Application Priority Data
Jul. 30, 2009 (JP) 2009-178190

(51) Int. Cl. G06F 9/455; G06F 9/46

(52) U.S. Cl. 718/1; 718/104

(57) ABSTRACT

A plurality of VMs work in a PC 10. Each VM is assigned with an I/O device that controls the VM. The PC performs monitoring continuously whether a reset key is handled to input reset instruction through the I/O device. When the reset key is handled to input reset instruction through the I/O device, the reset processing is started for the VM corresponding to the reset instruction.

### CROSS-REFERENCE TO RELATED APPLICATION

This application is based upon and claims the benefit of priority of the prior Japanese Patent Application No. 2009-178190 filed on Jul. 30, 2009, the entire contents of which are incorporated herein by reference.

### FIELD

The present invention relates to an information processing apparatus, an image processing method and a computer program for allowing reset of an operating virtual machine with utilizing an input/output device assigned to a virtual machine.

### BACKGROUND

It becomes capable of performing a complex processing in a short period of time, owing to the recent technological advances in the hardware resources of computer, such as a central processing unit (CPU) or a memory. When a computer is utilized for a simple processing, such as a document creation processing, hardware resources of the computer may not be fully utilized. It is desirable to efficiently utilize surplus hardware resources that are not utilized yet. Thus, a virtualization technology is proposed for virtually dividing hardware resources. In such the virtualization technology, hardware resources of an actual computer are virtually divided into a plurality of partitions and the actual computer performs processing as if each partition performs processing on the actual computer. In other words, this virtualization technology can virtually create a plurality of computers on one actual computer and can make the plurality of computers virtually operate independently to one another. Such a virtually created computer is called a virtual machine (VM) that performs virtual operations.

It is possible to connect devices including a mouse, a display and the like to each VM on such the actual computer. Assume that four VMs operate on one actual computer. In this assumption, four pairs of devices may be connected to the actual computer. In response to being connected with such four pairs of devices, the actual computer starts to assign the connected device to each partition. Thus, users can handle the VM through the assigned devices.

When a plurality of VMs is created on one actual computer with such the virtualization technology, a plurality of users can utilize this actual computer at the same time. Thus, it can be led to save space and electric power. However, in the case that a hang (malfunction, pause or the like) occurs to one VM among a plurality of VMs operating on the actual computer, it may be required to reset the actual computer through pushing a reset button, a power button or the like of the actual computer. The hang occurred on one VM may result in a problem that the reset of actual computer causes the resets of the other VMs at the same time. Hence, the resets of the other VMs make current users stop utilizing the other VMs. Therefore, the hang occurred on one VM may cause great influences on users.

The reset of the actual computer results in a problem causing a requirement of re-assigning devices to partitions, too. Thus, it is required to re-assign devices to partitions after the reset of the actual computer, similarly before the reset of the actual computer, in order to allow the current users to re-utilize the same VMs as those before the reset of the actual computer.

A method is described in Japanese National Publication of International Patent Application No. 2004-523048 that prepares a system console dedicated to an administrator of the actual computer in advance and executes a reset procedure for the hang-occurred VM in response to the system console handled by the administrator. Furthermore, a method is described in Japanese National Publication of International Patent Application No. 2007-510198 that prepares a system console dedicated to an administrator of the actual computer, makes database store assignment information of resources to partitions, and re-assigns the resources to the partitions after the reset of the actual computer similarly before the reset of the actual computer.

### SUMMARY

The conventional method as described above requires preparing a system console dedicated to an administrator, requesting the administrator in the case that a user wants to perform the reset of utilizing VM, and the like. Therefore, the conventional method may have a disadvantage lied in the fact that some disturbing requirements has to be met for resetting the utilizing VM.

The present invention is made in view of such circumstances, and has a primary object to provide an information processing apparatus, an image processing method and computer program that can allow a user utilizing a VM to reset the VM in response to the user's handling.

An information processing apparatus according to the present invention logically divides physical resources and works the divided physical resources as a plurality of VMs. Furthermore, an information processing apparatus according to the present invention assigns a plurality of input/output means for inputting/outputting data to a plurality of operating VMs, transmits data from the input means to a VM to which the input means is assigned, and transmits data from the VM to an output means. Moreover, an information processing apparatus according to the present invention inactivates a VM in response to detecting predetermined data input by an input/output means, and then re-activates the inactivated VM.

In an information processing apparatus according to the present invention, a user utilizing a VM can instruct to reset a VM through handling an input/output means assigned to the utilizing VM.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic view illustrating configurations of PC according to embodiment 1.

FIG. 2 is a block diagram illustrating configurations of PC according to embodiment 1.

FIG. 3 is a schematic view illustrating contents of a table stored in PC.

FIG. 4 is a schematic view illustrating contents of a table stored in PC.

FIG. 5 is a block diagram illustrating functions of PC according to embodiment 1.

FIG. 6 is a schematic view illustrating an example of display for informing of reset.

FIG. 7 is a flowchart illustrating a procedure performed by VMM and management OS according to embodiment 1.

FIG. 8 is a flowchart illustrating a procedure performed by VMM and management OS according to embodiment 1.

FIG. 9 is a flowchart illustrating a procedure performed by VMM and management OS according to embodiment 1.

FIG. 10 is a flowchart illustrating a procedure performed by I/O monitoring unit.

FIG. 11 is a flowchart illustrating a procedure performed by key input monitoring unit.

FIG. 12 is a flowchart illustrating a procedure performed by reset control unit.

FIG. 13 is a flowchart illustrating a procedure performed by reset control unit.

FIG. 14 is a schematic view illustrating configurations of PC according to embodiment 2.

FIG. 15 is a flowchart illustrating a procedure performed by VMM and management OS according to embodiment 2.

FIG. 16 is a flowchart illustrating a procedure performed by VMM and management OS according to embodiment 2.

FIG. 17 is a schematic view illustrating an example of display for setting and changing the reset key that introduces the reset processing.

FIG. 18 is a schematic view illustrating contents of VM management table according to embodiment 3.

FIG. 19 is a block diagram illustrating functions of PC according to embodiment 3.

FIG. 20 is a flowchart illustrating a procedure performed by input key setting unit and reset control unit.

FIG. 21 is a schematic view illustrating an example of authentication screen on monitor display device.

FIG. 22 is a schematic view illustrating contents of VM management table according to embodiment 4.

FIG. 23 is a block diagram illustrating functions of PC according to embodiment 4.

FIG. 24 is a schematic view illustrating another example of authentication screen on monitor display device.

FIG. 25 is a flowchart illustrating a procedure performed by VMM, management OS and guest OS according to embodiment 4.

FIG. 26 is a flowchart illustrating a procedure performed by VMM, management OS and guest OS according to embodiment 4.

FIG. 27 is a schematic view illustrating an example of authentication screen on monitor display device.

FIG. 28 is a schematic view illustrating another example of authentication screen on monitor display device.

FIG. 29 is a block diagram illustrating functions of PC according to embodiment 5.

FIG. 30 is a schematic view illustrating contents of VM management table according to embodiment 5.

FIG. 31 is a flowchart illustrating a procedure performed by VMM, management OS and guest OS according to embodiment 5.

FIG. 32 is a flowchart illustrating a procedure performed by VMM, management OS and guest OS according to embodiment 5.

FIG. 33 is a block diagram illustrating functions of PC according to embodiment 6.

FIG. 34 is a schematic view illustrating contents of VM management table according to embodiment 6.

FIG. 35 is a flowchart illustrating a procedure performed by VMM, management OS and guest OS according to embodiment 6.

### DESCRIPTION OF EMBODIMENTS

Hereinafter, it is described in detail with reference to drawings about embodiments of information processing apparatus, image processing method and computer program according to the present invention. In the following descriptions, an information processing apparatus according to the present invention is explained in the context of a personal computer (PC). It should be noted that an information processing apparatus according to the present invention may be a server apparatus that is connected to, for example, local area network (LAN) or wide area network (WAN), too.

### Embodiment 1

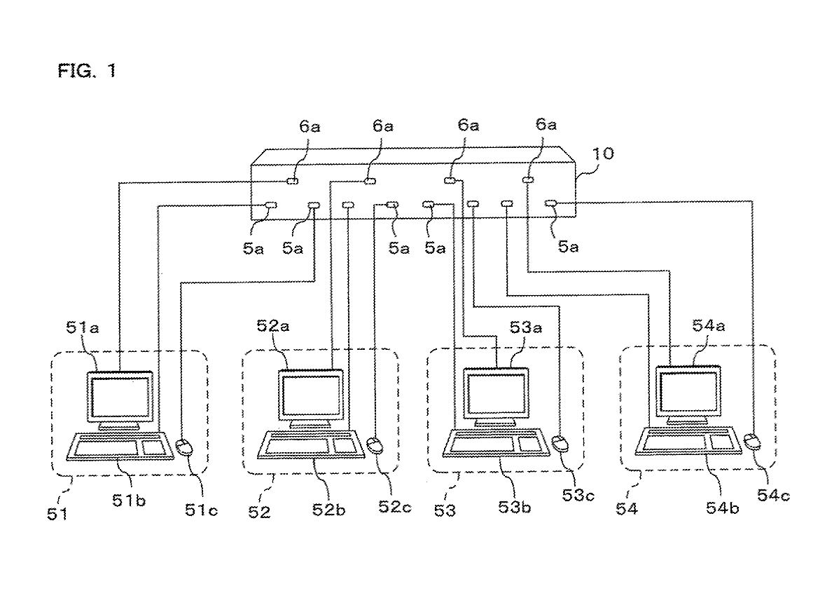

It is described below about a PC of embodiment 1. FIG. 1 is a schematic view illustrating configurations of the PC according to embodiment 1.

The PC 10 has a housing on which eight universal serial bus (USB) ports 5a, 5a, . . . are provided and four connecting ports 6a, 6a, . . . for monitor display devices are provided. The eight USB ports 5a, 5a, . . . are aligned horizontally on the low portion of the side surface of the PC 10, and the four connecting ports 6a, 6a, . . . are aligned horizontally above the USB ports 5a, 5a, . . . in FIG. 1. The USB ports 5a, 5a, . . . are connected through USB cables to four key boards 51b, 52b, 53b, 54b and to four computer mice 51c, 52c, 53c, 54c. The connecting ports 6a, 6a, . . . are connected to four monitor display devices 51a, 52a, 53a, 54a through connection cables for monitor display devices. Thus, it is possible on the PC 10 to prepare input/output (I/O) devices 51, 52, 53, 54 including monitor display devices 51a, 52a, 53a, 54a, key boards 51b, 52b, 53b, 54b and computer mice 51c, 52c, 53c, 54c, respectively.

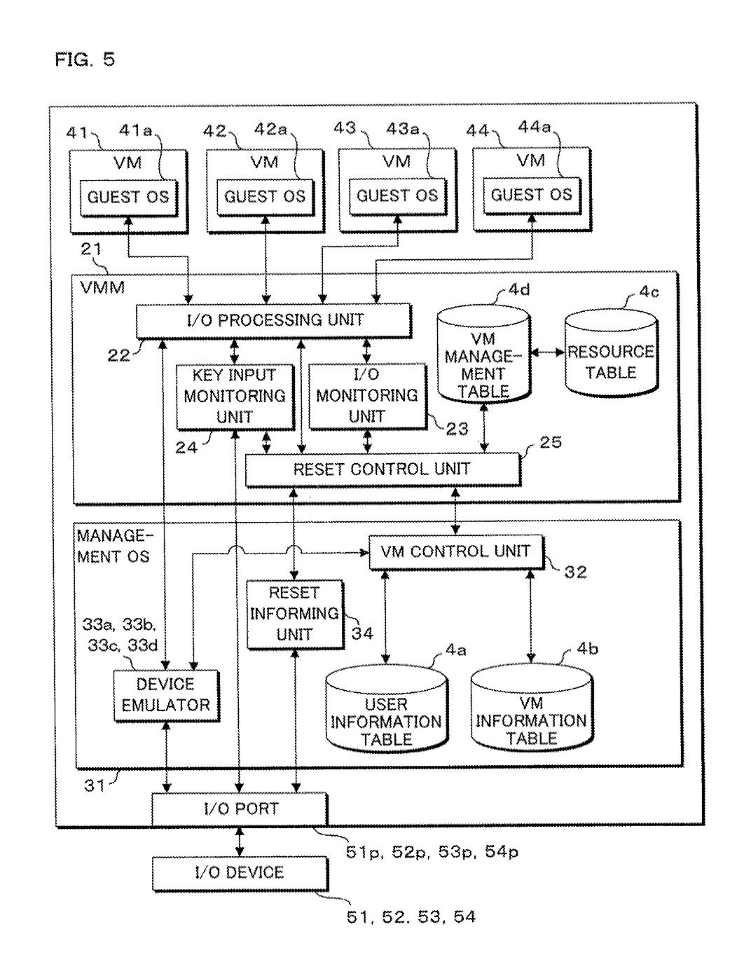

The PC 10 of embodiment 1 can create operable VMs 41, 42, 43, 44 (See FIG. 5) with utilizing the virtualization technology. The VMs 41, 42, 43, 44 are virtual computers, each of which independently implements an operating system and applications, similarly to an actual computer. To the VM 41 (42, 43 or 44), the I/O device 51 (52, 53 or 54) is assigned. Thus, the PC 10 of embodiment 1 can work as if being four PCs.

A user can utilize the VM 41 (42, 43 or 44) through handling the I/O device 51 (52, 53 or 54). The following descriptions explain the case that a predetermined reset manipulation is carried out with the key board 51b (52b, 53b or 54b) of the I/O device 51 (52, 53 or 54) and then the VM 41 (42, 43 or 44) is reset. It should be noted that the I/O device 51 is assigned to the VM 41, the I/O device 52 is assigned to the VM 42, the I/O device 53 is assigned to the VM 43, and the I/O device 54 is assigned to the VM 44, in the following descriptions.

The information processing apparatus according to the present invention is not limited to the PC described above. For example, it is not limited to have eight USB ports 5a, 5a, . . . , and four connecting ports 6a, 6a, . . . . It may be possible, as the information processing apparatus according to the present invention, to utilize the PC 10 that is modified to have a USB hub connected to one USB port 5a and to establish connections of a plurality of key boards and computer mice through the USB hub. Furthermore, it is not limited to create four VMs virtually on the PC 10. Moreover, it is possible to change the assignment combination between the VMs 41, 42, 43, 44 and the I/O devices 51, 52, 53, 54.

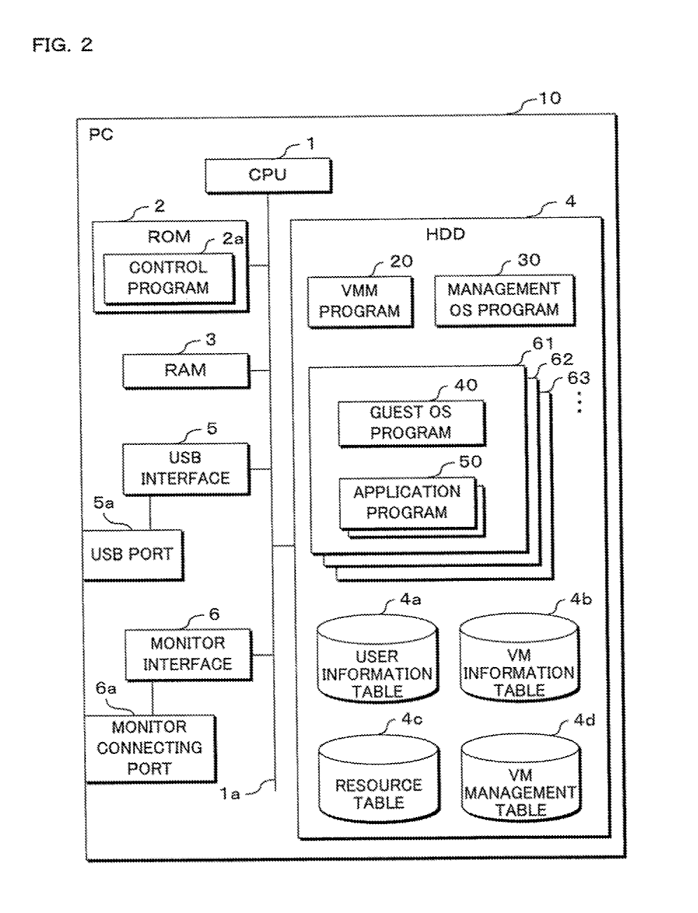

FIG. 2 is a block diagram illustrating configurations of PC according to embodiment 1.

The PC 10 of embodiment 1 includes hardware units: such as a CPU 1, a read only memory (ROM) 2, a random access memory (RAM) 3, a hard disk drive (HDD) 4, a USB interface 5, and monitor display device interface 6. These hardware units are connected to each other through a bus 1a.

The CPU 1 properly reads out control program that is previously stored on the ROM 2 or the HDD 4, executes the read control program and controls operations of the hardware units described above. The RAM 3 is, for example, a static RAM (SRAM), a dynamic RAM (DRAM), a flash memory or the like. The RAM 3 temporally stores various data generated during the period that the control program is executed by the CPU 1.

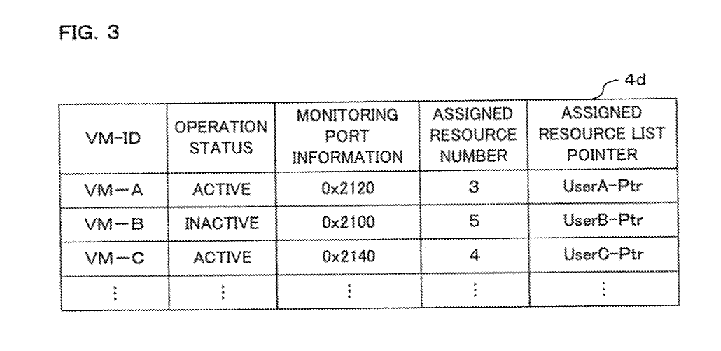

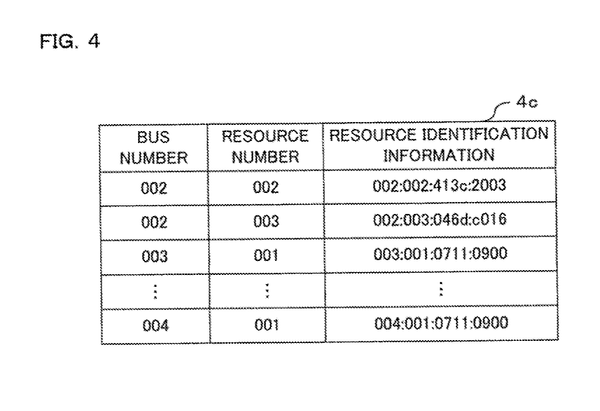

The HDD 4 is a large capacity storage device, and stores various control program and various data required for allowing the PC 10 to work as the information processing apparatus according to the present invention. For example, the HDD 4 stores VM monitoring program (VMM program) 20 described later, management OS program 30, four of guest OS program, application program 50, and the like. Each program 20, 30, 40, 50 is read out onto the RAM 3 and executed by the CPU 1. In addition, the HDD 4 further stores a user information table 4a, a VM information table 4b, a resource table 4c, a VM management table 4d and the like that are illustrated in FIG. 3 and FIG. 4 and are described later.

The USB interface 5 is connected to eight USB ports 5a, 5a, . . . , and performs data communication with the devices connected to the USB interface 5 through the USB cables of the USB ports 5a, 5a, . . . . The USB interface 5 of embodiment 1 is connected to the key boards 51b, 52b, 53b, 54b and to the computer mice 51c, 52c, 53c, 54c through the USB cables. Thus, the USB interface 5 performs data communication with the key boards 51b, 52b, 53b, 54b and with the computer mice 51c, 52c, 53c, 54c.

The key boards 51b, 52b, 53b, 54b and the computer mice 51c, 52c, 53c, 54c include various detection parts required for detecting user's manipulation of the PC10. When a user handles an operation key on the key boards 51b, 52b, 53b, 54b and the computer mice 51c, 52c, 53c, 54c, the key boards 51b, 52b, 53b, 54b and the computer mice 51c, 52c, 53c, 54c output a control signal corresponding to the operation key handled by the user.

The monitor interface 6 is connected to four monitor connecting ports 6a, 6a, . . . . The monitor interface 6 of embodiment 1 is connected to the monitor display devices 51a, 52a, 53a, 54a through the connection cables for the monitor display devices that are respectively connected to the monitor connecting ports 6a, 6a, . . . . Thus, the monitor interface 6 performs data communication with the monitor display devices 51a, 52a, 53a, 54a.

The monitor display devices 51a, 52a, 53a, 54a are liquid crystal displays, cathode ray tube (CRT) display or the like, and the monitor display devices 51a, 52a, 53a, 54a display required information based on the data sent from the corresponding VMs 41, 42, 43, 44 through the monitor interface 6. For example, the monitor display devices 51a, 52a, 53a, 54a display operation status information of the PC 10, information input by users, information to be informed to users, and the like.

It will be described below about the management OS program 30, the guest OS program, the application program 50 and the tables stored on the HDD 4 described above. Each program 20, 30, 40, 50 is read out from the RAM 3 and executed by the CPU 1.

The VMM program 20 is software program for implementing the virtualization technology that creates operable VMs 41, 42, 43, 44 on the PC 10. The CPU 1 executes the VMM program 20 after the PC 10 is activated, and then starts working as a VM monitor (VMM) 21. When the CPU works as the VMM 21, the PC is provided with virtual environment that allows the VMs 41, 42, 43, 44 to operate independently to each other.

The management OS program 30 is software program for implementing a function to activate the VMs 41, 42, 43, 44 on the virtual environment, a function to inactivate the VMs 41, 42, 43, 44 on the virtual environment, a function to assign resources to the VMs 41, 42, 43, 44 and a function to release the assigned resources. The CPU 1 loads the VMM program 20 onto the RAM 3 and then executes the management OS program 30 to start working as a management OS described later. The resources assigned to the VMs 41, 42, 43, 44 are the CPU 1, the RAM 3, the HDD 4, the I/O devices 51, 52, 53, 54 and the like.

Numerals 61, 62, 63, . . . in FIG. 2 are VM disk images, each of which is a disk image utilized for the VM and includes the guest OS program 40 and the application program 50. The VM disk images 61, 62, 63, . . . are required for each VM to be activated. Furthermore, the guest OS program and the application program in the VM disk images 61, 62, 63, . . . are different in accordance with a user utilizing the VM. The guest OS program 40 is software program for implementing OS (guest OS) on the VMs 41, 42, 43, 44. The CPU 1 loads the VM disk images 61, 62, 63, . . . on the RAM 3 after the VMs 41, 42, 43, 44 are activated. Then, the CPU 1 executes the guest OS program 40 to start working as the guest OS. The guest OS is, for example, Windows (registered trade mark), Linux (registered trade mark) or the like. The guest OS creates a display screen image in accordance with performed processing, and the display screen contains proper command user interface (CUI), graphic user interface (GUI) and the like to be displayed. The guest OS makes the monitor display device 51a (52a, 53a or 54a) assigned to the own VM 41 (42, 43 or 44) display the created display screen image. In addition, the guest OS receives control signals from the assigned key board 51b (52b, 53b or 54b) and the assigned computer mouse 51c (52c, 53c or 54c). Thus, the guest OS works as a performing means for performing various processes based on the received control signal.

The application program 50 is software program executed by each guest OS. The VMs 41, 42, 43, 44 may read out the application program 50 from an external memory storing the application program 50 and may store the read application program 50 onto the VM disk images 61, 62, 63, . . . . In the case that communication units are provided to the VMs 41, 42, 43, 44 for connecting the VMs 41, 42, 43, 44 to network, the VMs 41, 42, 43, 44 may download the application program 50 through the network and store the downloaded application program 50 onto the VM disk images 61, 62, 63, . . . .

FIG. 3 and FIG. 4 are schematic views illustrating contents of tables stored in the PC 10. FIG. 3 shows stored contents of the VM management table 4d, and FIG. 4 shows stored contents of the resource table 4c.

As illustrated in FIG. 3, the VM management table 4d contains ID information (VM-ID), operation status information, monitoring port information, assigned resource number information, and assigned resource list information of the VMs 41, 42, 43, 44. The operation status information indicates a status of the VM 41 (42, 43, or 44) corresponding to the VM-ID, such as “active” or “inactive”. As the CPU 1 monitors key input from the key board 51b (52b, 53b or 54b) during the VM 41 (42, 43 or 44) is operating, the monitoring port information indicates a USB port from which the CPU 1 should monitor the key input. The assigned resource number information indicates a number of resources assigned to the working VM 41 (42, 43 or 44). In the case that the VM 41 (42, 43 or 44) is provided with a keyboard, a computer mouse and a monitor display device, the assigned resource number information is “3”. The assigned resource list information is address information for accessing the resource table 4c that stores the resource information. The operating VM 41 (42, 43 or 44) may be provided with, for example, an assigned keyboard 51b (52b, 53b or 54b) based on resource information obtained from the resource table 4c in accordance with the assigned resource list information. Contents of the VM management table 4d are registered at the initialization of the PC10 and are updated at the start and the stop of the VM 41 (42, 43 or 44).

As illustrated in FIG. 4, the resource table 4c stores a list about resource information of all resources connected to the PC 10. The resource information indicates monitor display devices, keyboards, computer mice and the like included in the I/O devices 51, 52, 53, 54. The resource table 4c is registered at the initialization of the PC10 and at the connection of the I/O device with the PC 10.

It will be described below about functions implemented by the CPU 1 of the PC 10 explained above, as the CPU 1 executes various control programs stored on the ROM 2 and the HDD 4. FIG. 5 is a block diagram illustrating functions of PC 10 according to embodiment 1.

FIG. 5 illustrates a status that four guest OSs 41a, 42a, 43a, 44a are respectively implemented in the four VMs 41, 42, 43, 44 operating on the PC 10 with the virtualization technology. In FIG. 5, the I/O ports 51p, 52p, 53p, 54p represent combinations of the USB ports 5a, 5a, . . . and the monitor display device connecting ports 6a, 6a, . . . . The I/O ports 51p, 52p, 53p, 54p are connected to the I/O devices 51, 52, 53, 54, respectively. The I/O devices 51, 52, 53, 54 are represented by a single block in FIG. 5. Similarly, the I/O ports 51p, 52p, 53p, 54p are represented by a single block in FIG. 5.

When the PC 10 of embodiment 1 is turned on and each hardware unit of the PC 10 is activated, the CPU 1 reads out the VMM program 20 from the HDD 4, executes the read program and starts to work as a virtual machine monitor (VMM) 21. After starting to work as the VMM 21, the CPU 1 reads out the management OS program 30 from the HDD 4, executes the read program and starts working as the management OS 31. FIG. 5 illustrates that the management OS 31 and the VMs 41, 42, 43, 44 can work independently to each other due to the function of VMM 21 in the PC 10.

Due to the modules contained in the VMM program 20, the VMM 21 has functions, such as an I/O processing unit 22 (transfer means), an I/O monitoring unit (monitoring means) 23, a key input monitoring unit (detecting means) 24, and a reset control unit 25. Due to modules contained in the management OS program 30, the management OS 31 has functions, such as a VM control unit (assigning means, inactivating means, activating means) 32, a device emulators 33a, 33b, 33c, 33d and a reset informing unit 34. The device emulators 33a, 33b, 33c, 33d are functions assigned to I/O ports 51p, 52p, 53p, 54p, respectively. In FIG. 5, the device emulators 33a, 33b, 33c, 33d are represented by a single block.

The VM control unit 32 is a function implemented by the management OS 31 and instructs activation of the VM 41 (42, 43 or 44). When having succeeded in the activation of the VM 41 (42, 43 or 44), the VM control unit 32 transmits a completion notice of activation instruction for informing that an activation instruction to the VM is completed, toward the reset control unit 25. When the VM 41 (42, 43 or 44) has been activated in response to the VM activation instruction, the VM disk image 61 (62, 63, or . . . ) is loaded, the guest OS program 40 is executed, and the guest OS 41a (42a, 43a or 44a) starts to work. When the VM 41 (42, 43 or 44) has been activated, the VM control unit 32 performs a user authentication. For example, the VM control unit 32 makes the monitor display devices of all the I/O devices 51, 52, 53, 54 display a login screen (not illustrated). A user can input a user ID and a password through the login screen by the key board and the computer mouse of the I/O devices 51, 52, 53, 54. The VM control unit 32 obtains the user ID and the password input through the login screen. The VM control unit 32 identifies the I/O device 51 (52, 53 or 54) that has transmitted the input user ID and password, and decides whether the obtained user ID and password are stored in the user information table 4a or not. When having decided that the obtained user ID and password are stored in the user information table 4a, the VM control unit 32 determines that the user authentication is succeeded.

When the user authentication has been succeeded, the VM control unit 32 reads out a VM-ID corresponding to the obtained user ID from the VM information table 4b. Then, the VM control unit 32 activates the VM 41 (42, 43 or 44) corresponding to the read VM-ID. Thus, it is possible on the PC 10 to activate the VM 41 (42, 43 or 44) assigned to the user who has input the user ID. The VM control unit 32 then transmits the completion notice of activation instruction representing that the VM 41 (42, 43 or 44) is completely activated, together with the read VM-ID, toward the reset control unit 25.

The VM control unit 32 receives a request notice of resource assignment from the reset control unit 25 to which the completion notice of activation instruction is transmitted. The request notice of resource assignment is for allowing the reset control unit 25 to make the VM control unit 32 start assigning resources to the activated VM 41 (42, 43 or 44). When having received the request notice of resource assignment, the VM control unit 32 receives from the reset control unit 25 resource information for the assignment, too. The VM control unit 32 assigns to the activated VM 41 (42, 43 or 44) with the I/O device 51 or the like based on the resource information. When having completed the resource assignment, the VM control unit 32 transmits a completion notice of resource assignment to the reset control unit 25.

In the guest OS 41a (42a, 43a or 44a), display driver, keyboard driver, computer mouse driver and the like are executed for working the monitor display device 51a (52a, 53a or 54a), the keyboard 51b (52b, 53b or 54b), the computer mouse 51c (52c, 53c or 54c) and the like. The following description explains about the case that a user assigned with VM 41 utilizes the I/O device 51.

The VM control unit 32 receives an inactivation request notice from the reset control unit 25. The inactivation request notice is transmitted from the reset control unit 25 that has started a reset processing to reset the VM 41. When having received the inactivation request notice, the VM control unit 32 inactivates the activated VM 41. When having completed the inactivation processing, the VM control unit 32 transmits an inactivation completion notice to the reset control unit 25. The VM control unit 32 receives a release request notice of assigned resources from the reset control unit 25 that has received the inactivation completion notice. The release request notice of assigned resources is for allowing the reset control unit 25 to make the VM control unit 32 release the resources assigned to the VM 41. When having received the release request notice of assigned resources, the VM control unit 32 releases the resources assigned to the VM 41. When having completed the release processing, the VM control unit 32 transmits a completion notice of releasing assigned resources. After transmitting the completion notice of releasing assigned resources, the VM control unit 32 receives an activation notice that is for allowing the VM control unit 32 to activate the VM 41. When having received the activation notice, the VM control unit 32 activates the inactivated VM 41.

The device emulator 33a is assigned to the VM 41 by the VM control unit 32. Thus, the device emulator 33a transfers input data from the I/O device 51 to the VM 41 through the I/O processing unit 22. Additionally, the device emulator 33a obtains data generated by the VM 41 through the I/O processing unit 22, and outputs the obtained data to the I/O device 51.

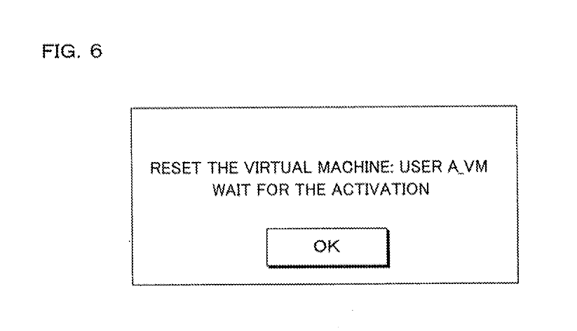

The reset informing unit 34 is informed by the reset control unit 25 of the fact that the reset processing is started. When having been informed of the fact that the reset processing is started, the reset informing unit 34 displays a reset notice screen on the monitor display device 51a. FIG. 6 is a schematic view illustrating an example of reset notice screen. On the reset notice screen, a name is displayed for the VM 41 that should be reset by the reset processing and a message is displayed to indicate the status that the reset processing is currently performed. The name for the VM 41 may be the VM-ID described above or may be set by the user. Instead of visual display of such information, sounds may be output from a speaker to inform of the fact that the reset processing is started.

The I/O processing unit 22 performs data processing between the VMs 41, 42, 43, 44 and the I/O devices 51, 52, 53, 54 (specifically, the device emulators 33a, 33b, 33c, 33d). The I/O processing unit 22 outputs, for example, data generated by the VM 41 to the I/O device 51 through the device emulator 33a. The data generated by the VM 41 is, for example, an I/O request. In embodiment 1, the I/O device 51 is an USB device and an USB driver is executed in the VM 41. The USB driver of the VM 41 implements to periodically sends an I/O request for the I/O device 51. The I/O processing unit 22 outputs the sent I/O request to the I/O device 51. When the I/O request has been input to the I/O device 51, the I/O device 51 outputs a response signal for the input I/O request. When having obtained the response signal through the device emulator 33a, the I/O processing unit 22 outputs to the VM 41 about the obtained response signal.

When the I/O request from the VM 41 has been input to the I/O processing unit 22, the I/O processing unit 22 informs the I/O monitoring unit 23 of the fact that the I/O request has been input. Thus, the I/O monitoring unit 23 can monitor whether the VM 41 periodically sends an I/O request or not. For informing of the fact, the I/O processing unit 22 may output a copy of the input I/O request or simple signal (e.g., “0” or “1”) to the I/O monitoring unit 23.

The I/O processing unit 22 outputs data that is input from the keyboard 51b, the computer mouse 51c and the like of the I/O device 51 to the VM 41. The I/O processing unit 22 outputs key information input from the keyboard 51b of the I/O device 51 to the key input monitoring unit 24. The key input monitoring unit 24 obtains the input key information that is output by the I/O processing unit 22, and then determines whether the key handled by the user for inputting data is the reset key utilized for reset processing instruction or not. The reset key is set for starting the reset processing. When the reset key is handled by the user to input reset processing instruction, the VM 41 is reset.

The I/O monitoring unit 23 receives a start notice of I/O request monitoring from the reset control unit 25. The start notice of I/O request monitoring is for allowing the reset control unit 25 having received the completion notice of resource assignment to make the I/O monitoring unit 23 start monitoring the I/O request that is periodically sent by the VM 41. At the time of receiving the start notice of I/O request monitoring, the I/O monitoring unit 23 further receives monitoring port information from the reset control unit 25. The monitoring port information is about the I/O port 51p corresponding to the activated VM 41, and is obtained from the VM management table 4d by the reset control unit 25. When having received the start notice of I/O request monitoring, the I/O monitoring unit 23 further transmits the monitoring port information and the start notice of I/O request monitoring to the I/O processing unit 22. When having received the start notice of I/O request monitoring and then having received an I/O request that is sent by the VM 41 and whose destination to be monitored is the I/O port, the I/O processing unit 22 informs the I/O monitoring unit 23 of the fact that the I/O request has been received (i.e., transmits a reception notice of I/O request).

The I/O monitoring unit 23 receives the reception notice of I/O request from the I/O processing unit 22, and confirms on the basis of the reception whether the VM 41 periodically sends the I/O request or not. When having received no reception notice of I/O request during a predetermined period, the I/O monitoring unit 23 assumes that the VM 41 is abnormally paused (hang-up/freeze). When the I/O processing unit 22 has re-started transmitting the reception notice of I/O request, the I/O monitoring unit 23 assumes that the VM 41 recovers to normal. The I/O monitoring unit 23 transmits a change notice for making the input monitoring unit 24 change a monitoring object of key input on the basis of the determination results whether the VM 41 is abnormally paused or not. As described later, the key input monitoring unit 24 monitors the I/O processing unit 22 or the I/O port 51p for monitoring the key input from the I/O device 51. When having assumed that the VM 41 is abnormally paused, the I/O monitoring unit 23 transmits both the monitoring object information (information of I/O port 51p in this case) and the change notice, in order to make the key input monitoring unit 24 change the monitoring object of key input and monitor the I/O port 51p. When having assumed that the VM 41 recovers to normal, the I/O monitoring unit 23 transmits both the monitoring object information (information of I/O processing unit 22 in this case) and the change notice, in order to make the key input monitoring unit 24 change the monitoring object of key input and monitor the I/O processing unit 22.

Further, the I/O monitoring unit 23 receives a stop notice of I/O request monitoring from the reset control unit 25. The stop notice of I/O request monitoring is for allowing the reset control unit 25 to make the I/O monitoring unit 23 stop monitoring the I/O request. When having received the stop notice of I/O request monitoring, the I/O monitoring unit 23 further transmits a stop notice of I/O request monitoring to the I/O processing unit 22. When having received the stop notice of I/O request monitoring, the I/O processing unit 22 stop transmitting the reception notice of I/O request to the I/O processing unit 22.

The key input monitoring unit 24 receives a start notice of input monitoring from the reset control unit 25 that has received the completion notice of resource assignment. The start notice of input monitoring is for allowing the reset control unit 25 to make the key input monitoring unit 24 start monitoring the input key from the keyboard of the I/O device 51. At the time of receiving the completion notice of resource assignment, the key input monitoring unit 24 receives I/O port information of monitoring object, similarly to the I/O monitoring unit 23. The key input monitoring unit 24 further transmits the I/O port information of monitoring object and the start notice of input monitoring toward the I/O processing unit 22. When having received the start notice of input monitoring, the I/O processing unit 22 transmits the monitoring port information, which is copied data of the input key information input from the I/O port 51p, toward the key input monitoring unit 24.

The key input monitoring unit 24 monitors whether the obtained input key information from the I/O processing unit 22 represents the reset processing instruction or not. The reset processing instruction may be input by handling a specific single key or combination of plural keys. When the reset processing instruction is input, the key input monitoring unit 24 transmits an input notice of reset instruction to the reset control unit 25.

When having received the change notice indicating that the I/O port 51p should become the monitoring object from the I/O monitoring unit 23, the key input monitoring unit 24 changes the monitoring object for key input, from the I/O processing unit 22 to the I/O port 51p. Thus, the key input monitoring unit 24 obtains directly from the I/O port 51p the copy data of the input key information input from the I/O device 51. At that time, the key input monitoring unit 24 transmits a stop notice of key input monitoring for making the I/O processing unit 22 stop monitoring the key input. When having received the stop notice of key input monitoring, the I/O processing unit 22 stops transmitting the copied data of the key input information to the key input monitoring unit 24.

When having received the change notice indicating that the I/O processing unit 22 should become the monitoring object from the I/O monitoring unit 23, the key input monitoring unit 24 changes the monitoring object for key input, from the I/O port 51p to the I/O processing unit 22. At that time, the key input monitoring unit 24 again transmits the start notice of input monitoring described above to the I/O processing unit 22, and obtains the copied data of the key input information from the I/O processing unit 22.

When having received the completion notice of activation instruction from the VM control unit 23, the reset control unit 25 updates the storage contents of the VM management table 4d and obtains required information. For example, the reset control unit 25 updates the operation status of the VM 41 from “inactive” to “active”. Further, the reset control unit 25 obtains the I/O port information of monitoring object and the resource information corresponding to the VM 41. The resource information indicates resources assigned to the VM 41 and is obtained from the resource table 4c based on the assigned resource list information stored in the VM management table 4d. The reset control unit 25 transmits both the obtained resource information and the request notice of resource assignment to the VM control unit 32.

The reset control unit 25 receives the completion notice of resource assignment from the VM control unit 32 that has transmitted the request notice of resource assignment. When having received the completion notice of resource assignment, the reset control unit 25 transmits both the obtained monitoring port information and the start notice of I/O request monitoring toward the I/O monitoring unit 23. Thus, the I/O monitoring unit 23 can monitor whether the VM 41 periodically sends the I/O request or not, as described above. In addition, the reset control unit 25 transmits both the obtained I/O port information of monitoring object and the start notice of input monitoring toward the key input monitoring unit 24. Thus, the key input monitoring unit 24 can monitor the input key from the keyboard 51b of the I/O device 51.

When having received the input notice of reset instruction from the key input monitoring unit 24, the reset control unit 25 starts the reset processing. The reset control unit 25 transmits a reset request notice for resetting the VM 41 that is an object to be reset by the reset processing, toward the VM control unit 32. When having received the reset request notice, the VM control unit 32 inactivates the activated VM 41 as described above. The reset control unit 25 receives a reset completion notice from the VM control unit 32 that has inactivated the VM 41. Then, the reset control unit 25 transmits the stop notice of I/O request monitoring to the I/O monitoring unit 23 and the stop notice of key input monitoring to the key input monitoring unit 24.

When having received the reset completion notice from the VM control unit 32, the reset control unit 25 further transmits the release request notice of assigned resources to the VM control unit 32. When having received the release request notice of assigned resources, the VM control unit 32 releases the resources assigned to the VM 41 and transmits the completion notice of releasing assigned resources to the reset control unit 25. When having received the completion notice of releasing assigned resources, the reset control unit 25 updates the VM management table 4d and transmits the activation notice for activating the VM 41 to the VM control unit 32.

It will be described below with flowcharts about the procedure performed by the PC 10 according to embodiment 1.

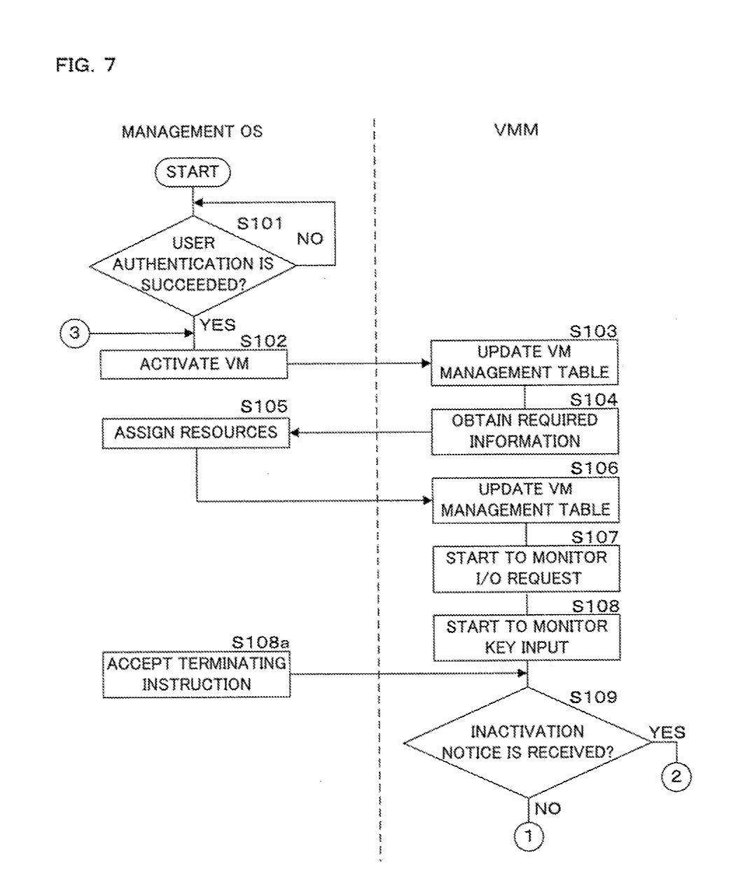

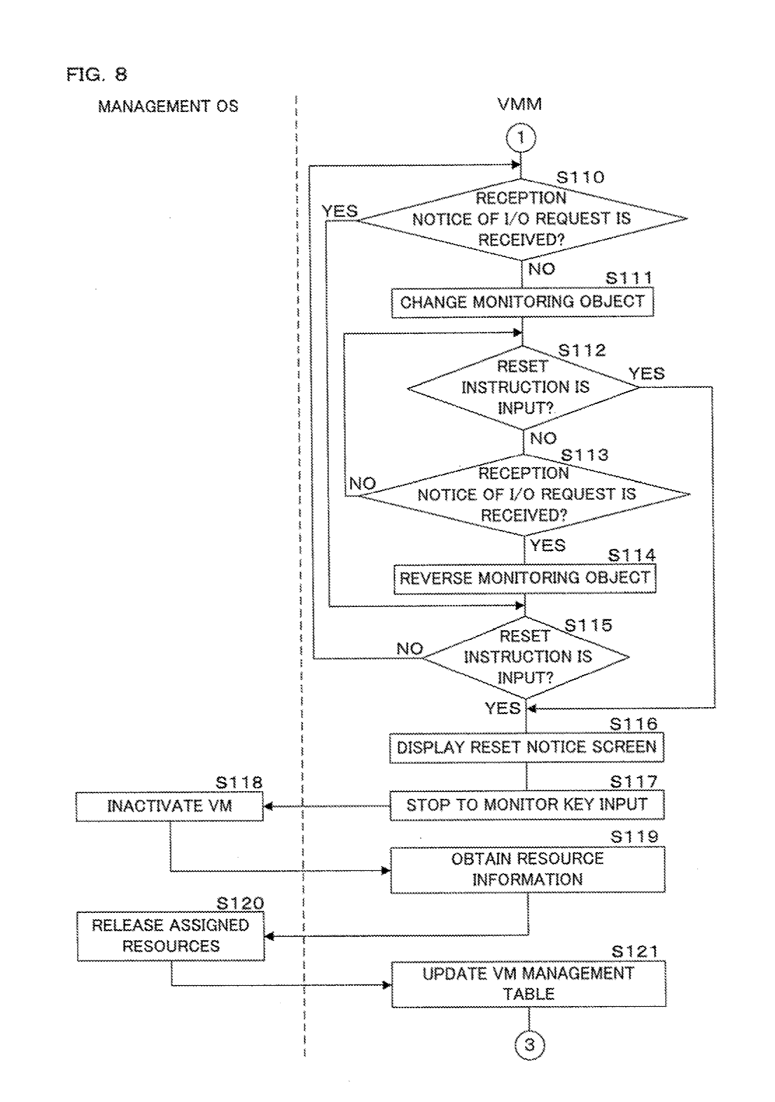

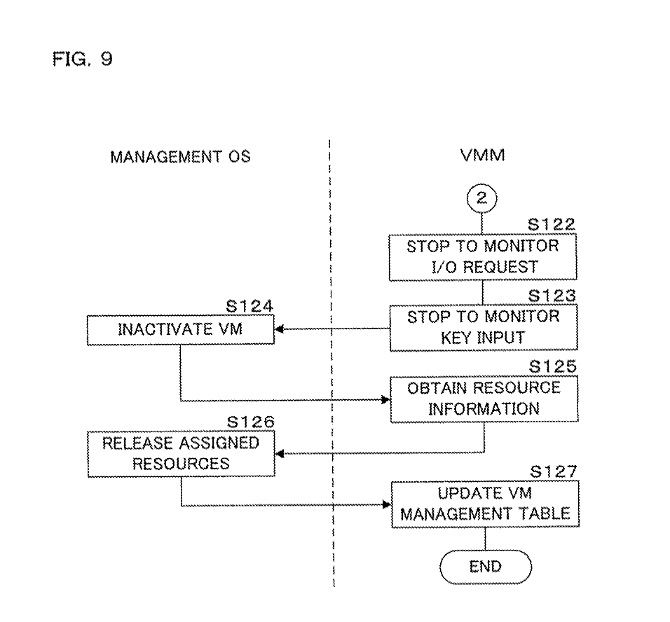

FIG. 7, FIG. 8 and FIG. 9 are flowcharts illustrating the procedure performed by the VMM 21 and the management OS 31 according to embodiment 1. The following procedure is performed by the CPU 1 that works as the VMM 21 and the management OS 31 based on the control program 2a stored in the ROM 2 or the HDD 4. In FIG. 7, FIG. 8 and FIG. 9, there are two regions separated by broken line. The left region illustrates processes performed by the management OS 31, and the right region illustrates processes performed by the VMM 21.

After the PC 10 is turned on and each hardware unit of the PC 10 is activated, the CPU 1 executes the VMM program 20 and works as the VMM 21. After starting to work as the VMM 21, the CPU 1 executes the management OS program 30 and works as the management OS 31.

The VM control unit 32 of the management OS 31 performs a user authentication and determines whether the user authentication is succeeded or not (S101). Specifically, the VM control unit 32 makes all the monitor display devices 51a, 52a, 53a, 54a display the login screen. Then, the VM control unit 32 decides whether user information including user ID and password is obtained through any of I/O devices 51, 52, 53, 54 or not. When having obtained the user information, the VM control unit 32 identifies the I/O device 51 that has transmitted the user information. The VM control unit 32 compares the obtained user information and the stored contents of the user information table 4a, and decides whether the user authentication is succeeded or not.

When having determined that the user authentication is not succeeded (S101: NO), the VM control unit 32 repeats the user authentication until succeeding. For example, when the obtained user information is not stored in the user information table 4a or when the obtainment of user information is failed, the VM control unit 32 determines that the user authentication is not succeeded. At that time, the management OS 31 may display an error notice screen on the monitor display device 51a of the I/O device 51 that has transmitted the user information.

When having determined that the user authentication is succeeded (S101: YES), the VM control unit 32 of the management OS 31 activates the VM 41 corresponding to the obtained user information (S102). The VM control unit 32 reads out VM-ID corresponding to the obtained user ID from the VM information table 4b, and then activates the VM 41 corresponding to the read VM-ID. Thus, the PC 10 can activate the VM 41 assigned to the user. The VM control unit 32 activates the VM 41 in response to receiving the activation notice for the VM 41. After the VM 41 is activated, the VM control unit 32 transmits the completion notice of activation instruction to the reset control unit 25.

The reset control unit 25 of the VMM 21 receives the VM-ID and the completion notice of activation instruction and updates the VM management table 4d based on the received VM-ID (S103). Further, the reset control unit 25 obtains information required for activating the VM 41 from the VM management table 4d (S104). Specifically, the reset control unit 25 identifies the activated VM 41 based on the received VM-ID and changes the operation status of the VM 41 from “inactive” to “active”. Then, the reset control unit 25 obtains the monitoring port information and the resource information corresponding to the VM 41 from the updated VM management table 4d. The reset control unit 25 transmits both the obtained resource information and the request notice of resource assignment to the VM control unit 32 of the management OS 31.

When having received the request notice of resource assignment, the VM control unit 32 of the management OS 31 assigns resources based on the received request notice of resource assignment, for example, the I/O device 51 to the activated VM 41 (S105). After assigning the resources, the VM control unit 32 transmits the completion notice of resource assignment to the reset control unit 25.

When having received the completion notice of resource assignment, the reset control unit 25 of the VMM 21 updates the assigned resource number information stored in the VM management table 4d and the assigned resource information stored in the resource table 4c (S106). Then, the reset control unit 25 of the VMM 21 starts monitoring I/O request (S107). Specifically, the reset control unit 25 transmits both the monitoring I/O port information obtained at S104 and the start notice of I/O request monitoring toward the I/O monitoring unit 23. Then, the I/O monitoring unit 23 transmits the start notice of I/O request monitoring to the I/O processing unit 22. Thus, the I/O processing unit 22 transmits the reception notice of I/O request to the I/O monitoring unit 23 in response to receiving the I/O request sent by the VM 41.

The reset control unit 25 of the VMM 21 sets the I/O monitoring unit 23 as the monitoring object for the key input, and starts the key input monitoring (S108). Specifically, the reset control unit 25 transmits both the monitoring I/O port information obtained at S104 and the start notice of input monitoring to the key input monitoring unit 24. Then, the key input monitoring unit 24 transmits the start notice of input monitoring to the I/O processing unit 22. Thus, the I/O processing unit 22 can start transmitting the copied data of the input key information input from the I/O device 51 toward the key input monitoring unit 24. The processes from S107 to S108 are performed at approximately the same time, and the performed order of the processes from S107 to S108 is not limited to the above description.

Next, the reset control unit 25 of the VMM 21 determines whether having received an inactivation notice for inactivating the VM or not (S109). The inactivation notice received by the reset control unit 25 is transmitted from the VM control unit 32 of the management OS 31, for example, when a user handles for normally terminating the usage of the VM 41 (S108a). Thus, when the inactivation notice is received at S109, the VMM 21 performs processes for normally inactivating the activated VM 41.

When the reset control unit 25 has determined that the VM inactivation notice is not received (S109: NO), the VM 41 is continuously utilized and the I/O monitoring unit 23 of the VMM 21 determines whether having received the reception notice of I/O request from the I/O processing unit 22 or not (S110). In the case that the VM 41 works normally, the I/O request is periodically sent by the VM 41, and thus the I/O monitoring unit 23 is periodically informed of the I/O request reception from the I/O processing unit 22. Hence, the I/O monitoring unit 23 determines that the I/O request is interrupted if the I/O request reception is not informed during a period longer than the period that the normal VM 41 sends the following I/O request.

When it has been determined that the reception notice of I/O request is continuously received from the I/O processing unit 22 (S110: YES), the VM 41 is considered to take no abnormal pause, and the procedure is proceeded to S115. When it has been determined that the continuous receiving is disrupted of the reception notice of I/O request (S110: NO), the I/O monitoring unit 23 determines that the VM 41 is abnormally paused and transmits both the monitoring object information (about the I/O port 51p, in this case) and the change notice to the key input monitoring unit 24. As having set the I/O monitoring unit 23 as the key input monitoring object, the key input monitoring unit 24 changes to set the I/O port 51p as the key input monitoring object in response to receiving the change notice (S111). Thus, the key input monitoring unit 24 starts obtaining input key information from the I/O port 51p and monitoring the key input.

The key input monitoring unit 24 determines whether the obtained input key information represents the reset processing instruction or not (S112). When key input monitoring unit 24 has determined that the obtained input key information does not represent the reset processing instruction (S112: NO), the I/O monitoring unit 23 determines whether the reception notice of I/O request is continuously received from the I/O processing unit 22 or not (S113). When the I/O monitoring unit 23 has determined that the continuous receiving is disrupted of the reception notice of I/O request (S113: NO), the I/O monitoring unit 23 assumes that the VM is still abnormally paused and the procedure is proceeded to S112.

When it has been determined that the reception notice of I/O request is continuously received again (S113: YES), the I/O monitoring unit 23 assumes that the VM 41 recovers from the abnormal pausing and currently transmits both the monitoring I/O port information (about the I/O processing unit 22, in this case) and the change notice to the key input monitoring unit 24. The key input monitoring unit 24 changes the key input monitoring object from the I/O port 51p to the I/O processing unit 22, in response to receiving the change notice (S114). Then, the key input monitoring unit 24 determines whether the input key information received from the I/O processing unit 22 represents the reset processing instruction or not (S115). When the key input monitoring unit 24 has determined that the received input key information does not represent the reset processing instruction (S115: NO), the I/O monitoring unit 23 performs the process at S110 and assumes again whether the VM 41 is abnormally paused or not.

When having determined that the input key information obtained from the I/O port 51p or that the I/O processing unit 22 represents the reset processing instruction (S112 or S115: YES), the key input monitoring unit 24 transmits the input notice of reset instruction to the reset control unit 25. Then, the VMM 21 and the management OS 31 start the reset processing. The reset control unit 25 informs of the start of the reset processing to the reset informing unit 34 in response to receiving the input notice of reset instruction, and the reset informing unit 34 makes the monitor display device 51a display the reset notice screen (S116).

After transmitting the input notice of reset instruction to the reset control unit 25, the key input monitoring unit 24 stops monitoring the key input (S117). In the case that the key input monitoring unit 24 sets the I/O processing unit 22 as the key input monitoring object at that time, the key input monitoring unit 24 transmits the stop notice of key input monitoring to the I/O processing unit 22. Then, the I/O processing unit 22 stops transmitting the copied data of the input key information toward the key input monitoring unit 24.

After receiving the input notice of reset instruction, the reset control unit 25 of the VMM 21 transmits the reset request notice to the VM control unit 32 of the management OS 31. After receiving the reset request notice, the VM control unit 32 of the management OS 31 inactivates the VM 41 to be inactive (S118), and transmits the reset completion notice to the reset control unit 25 of the VMM 21.

After receiving the reset completion notice, the reset control unit 25 of the VMM 21 obtains resource information corresponding to the inactivated VM 41 from the VM management table 4d (S119). Then, the reset control unit 25 transmits both the obtained resource information and the release request notice of assigned resources to the VM control unit 32 of the management OS 31. After receiving the release request notice of assigned resources, the VM control unit 32 of the management OS 31 releases the resources assigned to the VM 41 in accordance with the resource information (S120). After completing the releasing processing of the assigned resources, the VM control unit 32 transmits the completion notice of releasing assigned resources toward the reset control unit 25 of the VMM 21. When having received the completion notice of releasing assigned resources, the reset control unit 25 of the VMM 21 updates the VM management table 4d (S121). For example, the reset control unit 25 changes the operation status of the inactivated VM 41 from the “active” to the “inactive”. In the case that the reset control unit 25 then transmits the activation notice to the VM control unit 32 of the management OS 31, the VM control unit 32 performs the process at S102 and the VM 41 is activated again. Then, the procedure is completed for the reset processing of the VM 41, in the case that the reset key is handled after the VM 41 is abnormally paused.

On the other hand, when the VM inactivation notice has been received at S109 (S109: YES), the reset control unit 25 of the VMM 21 stops monitoring the I/O request in order to terminates normally the usage of the VM 41 (S122). Specifically, the reset control unit 25 transmits the stop notice of I/O request monitoring to the I/O monitoring unit 23. When having received the stop notice of I/O request monitoring, the I/O monitoring unit 23 further transmits the stop notice of I/O request monitoring to the I/O processing unit 22. Then, the I/O processing unit 22 stops transmitting the reception notice of I/O request toward the I/O monitoring unit 23.

The reset control unit 25 of the VMM 21 stops monitoring the key input (S123). The reset control unit 25 transmits the stop notice of key input monitoring to the key input monitoring unit 24. In the case that the key input monitoring unit 24 sets the I/O processing unit 22 as the key input monitoring object at that time, the key input monitoring unit 24 further transmits the stop notice of key input monitoring to the I/O processing unit 22 in response to receiving the stop notice of key input monitoring. Then, the I/O processing unit 22 stops transmitting the copied data of the input key information toward the key input monitoring unit 24.

The VM 41 is inactivated by the management OS 31 (S214), and the VM control unit 32 transmits the inactivation completion notice to the reset control unit 25 of the VMM 21 in response to detecting the inactivating of the VM. When having received the inactivation completion notice, the reset control unit 25 of the VMM 21 obtains the resource information corresponding to the inactivated VM 41 from the VM management table 4d (S125). Then, the reset control unit 25 transmits both the obtained resource information and the release request notice of assigned resources to the VM control unit 32 of the management OS 31.

After receiving the release request notice of assigned resources, the VM control unit 32 of the management OS 31 releases the resources assigned to the VM 41 in accordance with the resource information (S126). After completing the releasing processing of the assigned resources, the VM control unit 32 transmits the completion notice of releasing assigned resources to the reset control unit 25 of the VMM 21. After receiving the completion notice of releasing assigned resources, the reset control unit 25 of the VMM 21 updates the VM management table 4d (S127). For example, the reset control unit 25 changes the operation status of the inactivated VM 41 from the “active” to the “inactive”. Then, the procedure is completed for the inactivation processing of the activated VM 41.

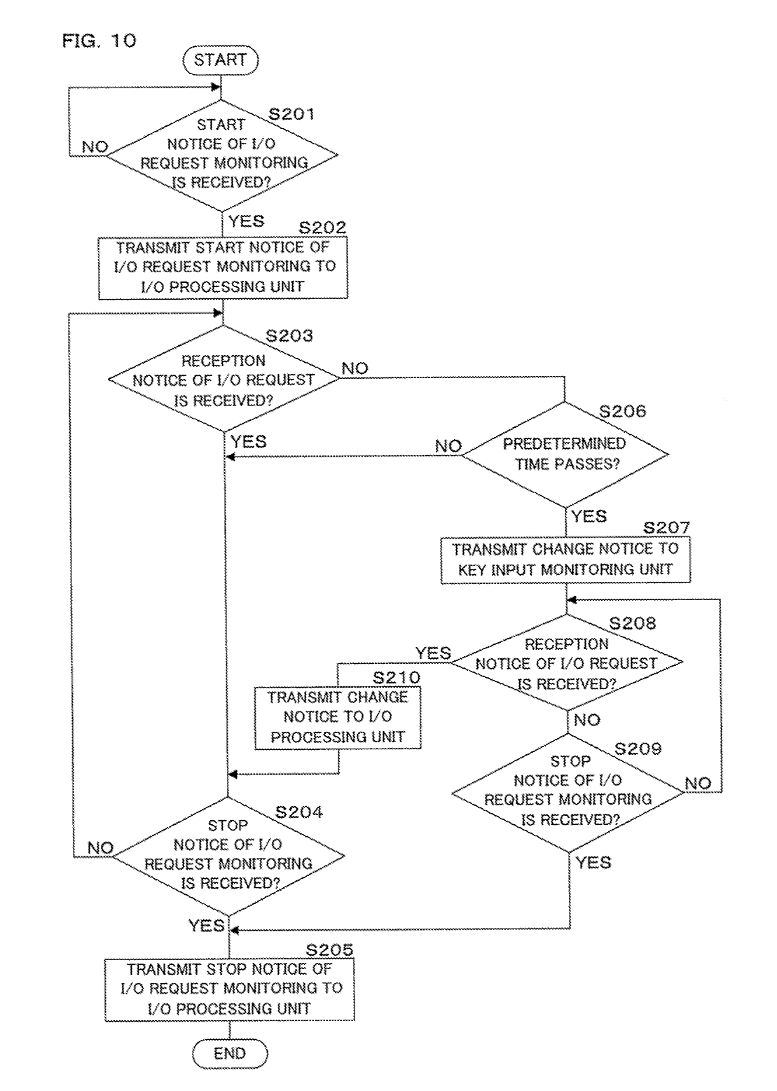

Next, it will be described about processing performed by the I/O monitoring unit 23, the key input monitoring unit 24 and the reset control unit 25 of the VMM 21. FIG. 10 is a flowchart illustrating a procedure performed by I/O monitoring unit 23.

The I/O monitoring unit 23 determines whether the start notice of I/O request monitoring has been received from the reset control unit 25 or not (S201). When having determined that the start notice of I/O request monitoring has not been received from the reset control unit 25 (S201: NO), the I/O monitoring unit 23 waits until receiving the start notice of I/O request monitoring. When having determined that the start notice of I/O request monitoring has been received from the reset control unit 25 (S201: YES), the I/O monitoring unit 23 transmits the start notice of I/O request monitoring to the I/O processing unit 22 (S202). Then, the I/O processing unit 22 starts transmitting the reception notice of I/O request to the I/O monitoring unit 23.

The I/O monitoring unit 23 determines whether the reception notice of I/O request has been received from the I/O processing unit 22 or not (S203). When having determined that the reception notice of I/O request has been received from the I/O processing unit 22 (S203: YES), the I/O monitoring unit 23 determines whether the stop notice of I/O request monitoring has been received from the reset control unit 25 or not (S204). The stop notice of I/O request monitoring is transmitted from the reset control unit 25 in the case that the VM 41 is inactivated. When having determined that the stop notice of I/O request monitoring has not been received (S204: NO), the I/O monitoring unit 23 performs the process at S203, i.e., determines whether the reception notice of I/O request has been received from the I/O processing unit 22 or not. When having determined that the stop notice of I/O request monitoring has been received (S204: YES), the I/O monitoring unit 23 further transmits the stop notice of I/O request monitoring to the I/O processing unit 22, too (S205). Then, the I/O processing unit 22 stops transmitting the reception notice of I/O request to the I/O monitoring unit 23.

When having determined that the reception notice of I/O request has not been received from the I/O processing unit 22 (S203: NO), the I/O monitoring unit 23 determines whether a predetermined time has passed or not (S206). For example, the I/O monitoring unit 23 determines whether the time lag between the time when the last reception notice of I/O request is received and the present time is no less than the interval in which the following I/O request is normally sent by the VM 41 or not. The predetermined time is set to be “n” times of the I/O request reception interval. The “n” is set in considering that it should be recognized as the abnormal when the reception of the I/O request is failed “n” consecutive times. For example, in the case that the I/O request reception interval is 200 ms and “10” is set in considering that it should be recognized as the abnormal when the reception of the I/O request is failed “10” consecutive times, the I/O monitoring unit 23 determines whether the time lag between the time when the last reception notice of I/O request is received and the present time is no less than 2000 ms or not. When having determined that the predetermined time has not passed (S206: NO), the I/O monitoring unit 23 performs the process at S204. When having determined that the predetermined time has passed (S206: YES), the I/O monitoring unit 23 recognizes that the VM 41 is abnormally paused, sets the monitoring object to be the I/O port 51p and transmits the change notice to the key input monitoring unit 24 (S207). Then, the key input monitoring unit 24 changes the key input monitoring object from the I/O processing unit 22 to the I/O port 51p.

After transmitting the change notice, the I/O monitoring unit 23 determines whether the reception notice of I/O request has been received from the I/O processing unit 22 or not (S208). When having determined that the reception notice of I/O request has not been received (S208: NO), the I/O monitoring unit 23 determines whether the stop notice of I/O request monitoring has been received from the reset control unit 25 or not (S209). When having determined that the stop notice of I/O request monitoring has not been received (S209: NO), the I/O monitoring unit 23 performs the process at S208, i.e., determines again whether the reception notice of I/O request has been received from the I/O processing unit 22 or not. When having determined that the stop notice of I/O request monitoring has been received (S209: YES), the I/O monitoring unit 23 further transmits stop notice of I/O request monitoring to the I/O processing unit 22 (S205), and stops monitoring the I/O request.

When having determined at S208 that the reception notice of I/O request has been received (S208: YES), the I/O monitoring unit 23 recognizes that the VM 41 recovers to normal, sets the monitoring object to be the key input monitoring unit 24, and transmits the change notice to the I/O processing unit 22 (S210). Then, the key input monitoring unit 24 changes the key input monitoring object from the I/O port 51p to the I/O processing unit 22, and the I/O monitoring unit 23 performs the procedure from S204.

As described above, the I/O monitoring unit 23 can determine whether the VM 41 is abnormally paused or not, on the basis of the monitoring result of the I/O request. In addition, the I/O monitoring unit 23 makes the key input monitoring unit 24 change the monitoring object for the key input, in accordance with the determination result.

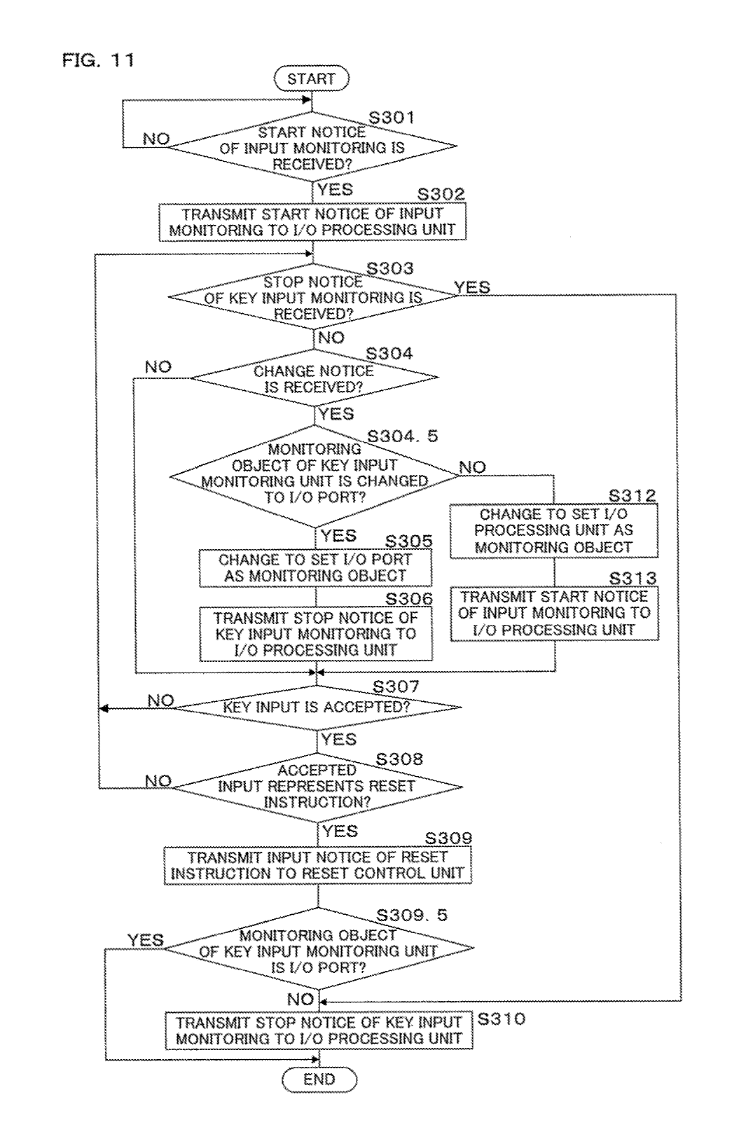

FIG. 11 is a flowchart illustrating a procedure performed by key input monitoring unit 24.

The key input monitoring unit 24 determines whether the start notice of input monitoring has been received in addition to the monitoring I/O port information from the reset control unit 25 or not (S301). When having determined that the start notice of input monitoring has not been received (S301: NO), the key input monitoring unit 24 waits until receiving the start notice of input monitoring. When having determined that the start notice of input monitoring has been received (S301: YES), the key input monitoring unit 24 transmits both the start notice of input monitoring and the monitoring I/O port information toward the I/O processing unit 22 (S302). Then, the transmission is started of the copied data of the input key information, toward the key input monitoring unit 24 from the I/O processing unit 22 that has obtained the input key information from the monitoring object I/O port.

The key input monitoring unit 24 decides whether the stop notice of key input monitoring has been received from the reset control unit 25 or not (S303). When having decided that the stop notice of key input monitoring has been received (S303: YES), the key input monitoring unit 24 transmits the stop notice of key input monitoring toward the I/O processing unit 22 (S310). Then, the I/O processing unit 22 makes the key input monitoring unit 24 stop transmitting the copied data of the input key information. When having decided that the stop notice of key input monitoring has not been received (S303: NO), the key input monitoring unit 24 determines whether the change notice has been received in addition to the monitoring object information from the I/O monitoring unit 23 or not (S304). When having determined that the change notice has been received (S304: YES), the key input monitoring unit 24 determines whether switching to set the I/O port 51p as the key input monitoring object (S304.5). When having decided that the next key input monitoring object is I/O port 51p (S304.5: YES), the key input monitoring unit 24 changes to set the I/O port 51p as the key input monitoring object (S305). In this case, the I/O monitoring unit 23 assumes that the VM 41 is abnormally paused. The key input monitoring unit 24 then transmits the stop notice of key input monitoring toward the I/O processing unit 22 (S306). Thus, the I/O processing unit 22 stops transmitting the copied data of the input key information toward the key input monitoring unit 24. When having determined that the change notice has not been received (S304: NO), the key input monitoring unit 24 determines whether the input key information has been obtained or not (S307). When having decided that the next key input monitoring object is I/O processing unit 22 (S304.5: NO), the key input monitoring unit 24 changes to set the I/O monitoring unit 22 as the key input monitoring object (S312). In this case, the I/O monitoring unit 23 assumes that the VM41 recovers to normal. Then, the key input monitoring unit 24 transmits the start notice of input monitoring to the I/O processing unit 22 (S313). Thus, the I/O processing unit 22 re-starts transmitting the copied data of the input key information toward the key input monitoring unit 24. And the key input monitoring unit 24 determines whether the input key information has been obtained or not (S307).

When having determined that the input key information has been obtained in response to user's handling (S307: YES), the key input monitoring unit 24 determines whether the input key information represents the reset processing instruction or not (S308). When having determined that the input key information represents the reset processing instruction (S308: YES), the key input monitoring unit 24 transmits the input notice of reset instruction to the reset control unit 25 in order to inform of the fact that the user has handled the reset key (S309). When having determined that the input key information has not been obtained (S307: NO), or when having determined that the input key information does not represent the reset processing instruction (S308: NO), the key input monitoring unit 24 performs the process at S303, i.e., determines whether the stop notice of key input monitoring has been received from the reset control unit 25 or not. Thus, the key input monitoring unit 24 determines whether the key input monitoring unit 24 sets the I/O port 51p as the key input monitoring object or not (S309.5). When having determined that the key input monitoring unit 24 sets the I/O processing unit 22 as the key input monitoring object, the key input monitoring unit 24 performs the process at S310 (S309.5: NO). Thus, the I/O processing unit 22 stops transmitting the copied data of the input key information toward the key input monitoring unit 24. After the key input monitoring unit 24 performs the process at S310 and when having determined the key input monitoring unit 24 sets the I/O port 51p as the key input monitoring object (S309.5: YES), the key input monitoring unit 24 stops monitoring the key input.

Then, the I/O monitoring unit 23 completes the procedure of the key input monitoring unit 24 in the case that the abnormally paused VM 41 recovers to normal.

As described above, the key input monitoring unit 24 changes the monitoring object for the reset instruction, in accordance with the operation status of the VM41, i.e., whether the VM 41 is abnormally paused or not.

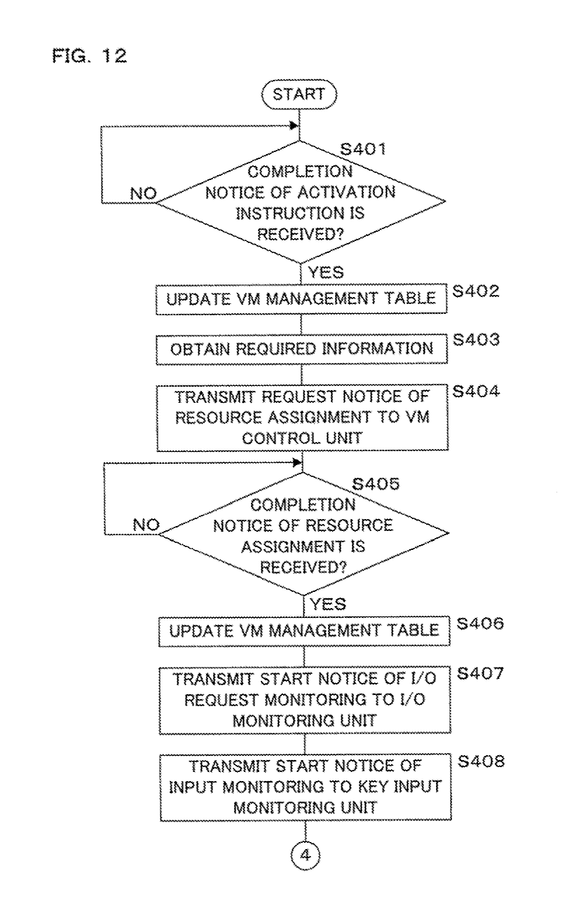

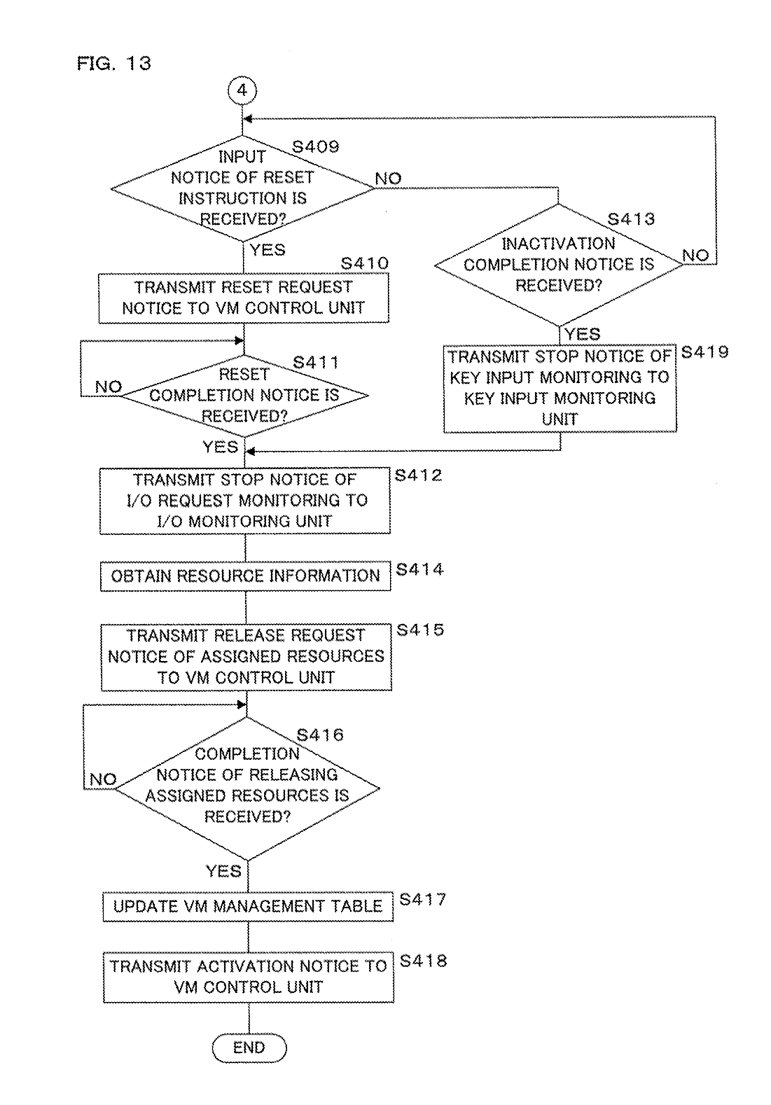

FIG. 12 and FIG. 13 are flowcharts illustrating procedures performed by reset control unit 25.

The reset control unit 25 determines whether the completion notice of activation instruction has been received from the VM control unit 32 or not (S401). The completion notice of activation instruction is transmitted from the VM control unit 32 that has completed activating the VM 41. When having determined that the completion notice of activation instruction has not been received (S401: NO), the reset control unit 25 waits until receiving the completion notice of activation instruction. When having determined that the completion notice of activation instruction has been received (S401: YES), the reset control unit 25 updates the VM management table 4d (S402), and obtains required information (S403). For example, the reset control unit 25 receives the VM-ID for identifying the activated VM 41, in addition to the completion notice of activation instruction. The reset control unit 25 updates the operation status of the VM 41 based on the received VM-ID, from the “inactive” to the “active”, and obtains the I/O port information of monitoring object and the resource information associated with the VM 41.

The reset control unit 25 transmits both the obtained resource information and the request notice of resource assignment toward the VM control unit 32 (S404). After receiving the request notice of resource assignment, the VM control unit 32 assigns resources to the activated VM 41 and transmits the completion notice of resource assignment. The reset control unit 25 determines whether the completion notice of resource assignment has been received or not (S405). When having determined that the completion notice of resource assignment has not been received (S405: NO), the reset control unit 25 waits until receiving the completion notice of resource assignment. When having determined that the completion notice of resource assignment has been received (S405: YES), the reset control unit 25 updates the VM management table 4d (S406). For example, the reset control unit 25 updates information about the resources assigned to the VM 41.

The reset control unit 25 transmits both the I/O port information of monitoring object obtained at S403 and the start notice of I/O request monitoring toward the I/O monitoring unit 23 (S407). Thus, the I/O monitoring unit 23 starts monitoring the I/O request from the I/O processing unit 22. Then, the reset control unit 25 transmits both the monitoring I/O port information and the start notice of input monitoring toward the key input monitoring unit 24 (S408). After receiving the start notice of input monitoring, the key input monitoring unit 24 starts monitoring the key input.

The reset control unit 25 determines whether the input notice of reset instruction has been received from the key input monitoring unit 24 or not (S409). The input notice of reset instruction is transmitted from the key input monitoring unit 24 in the case that the user has handled the reset key. After receiving the input notice of reset instruction, the reset control unit 25 starts processing for re-activating the VM 41. When having determined that the input notice of reset instruction has not been received (S409: NO), the reset control unit 25 determines whether the inactivation completion notice has been received from the VM control unit 32 or not (S413). This received inactivation completion notice is transmitted from the VM control unit 32 in the case that the VM 41 is inactivated, for example, in response to the inactivation instruction input by the user. When having determined that the inactivation completion notice has not been received (S413: NO), the reset control unit 25 returns the procedure to S409. When having determined that the inactivation completion notice has been received (S413: YES), the reset control unit 25 transmits the stop notice of key input monitoring to the key input monitoring unit 24 (S419). Then, the key input monitoring unit 24 stops monitoring the key input.

On the other hand, when having determined at S409 that the input notice of reset instruction has been received (S409: YES), i.e., when the user has input the reset instruction, the reset control unit 25 starts the reset processing for the VM 41 and transmits the reset request notice of the VM toward the VM control unit 32 (S410). After receiving the reset request notice, the VM control unit 32 inactivates the VM 41 and transmits the reset completion notice to the reset control unit 25. The reset control unit 25 determines whether the reset completion notice has been received or not (S411). When having determined that the reset completion notice has not been received (S411: NO), the reset control unit 25 waits until receiving the reset completion notice. When having determined that the reset completion notice has been received (S411: YES), the reset control unit 25 transmits the stop notice of I/O request monitoring toward the I/O monitoring unit 23 (S412). Then, the I/O monitoring unit 23 stops monitoring the I/O request.

The reset control unit 25 obtains resource information about the resources assigned to the inactivated VM 41 from the VM management table 4d (S414) and transmits both the obtained resource information and the release request notice of assigned resources to the VM control unit 32 (S415). After receiving the release request notice of assigned resources, the VM control unit 32 releases the resources assigned to the inactivated VM 41, and transmits the completion notice of releasing assigned resources toward the reset control unit 25. The reset control unit 25 determines whether the completion notice of releasing assigned resources has been received or not (S416).

When having determined that the completion notice of releasing assigned resources has not been received (S416: NO), the reset control unit 25 waits until receiving the completion notice of releasing assigned resources. When having determined that the completion notice of releasing assigned resources has been received (S416: YES), the reset control unit 25 updates the operation status of the VM 41 in the VM management table 4d, from the “active” to the “inactive” (S417). The reset control unit 25 then transmits the activation notice to the VM control unit 32 (S418). Thus, the VM 41 is activated again. The reset control unit 25 can re-activate the VM 41 through performing the procedure from the S401.

As described above, the reset control unit 25 can assign resources to the working VM 41, and can release the resources assigned to the inactivating VM 41. Furthermore, the reset control unit 25 can assign to the re-activated VM 41 with the same resources as those having been assigned to the re-activated VM 41 before having been re-activated.

It is possible in embodiment 1 to reset the abnormally paused VM 41 (42, 43 or 44) from the I/O device 51 (52, 53 or 54) assigned to the abnormally paused VM 41 (42, 43 or 44), as described above. Therefore, it is not required to prepare such a system console dedicated to the reset processing of the PC 10.

### Embodiment 2

It will be described below about the PC according to embodiment 2. The configurations of the PC according to embodiment 2 are similar to those of the PC 10 according to embodiment 1 described above. The similar configurations of the PC according to embodiment 2 are provided with the same numerals corresponding to the configurations of the PC 10 according to embodiment 1, and are not explained in detail.

The management OS 31 in embodiment 1 described above includes the functions of the device emulators 33a, 33b, 33c, 33d. On the other hand, the management OS 31 in embodiment 2 does not include the functions of the device emulators 33a, 33b, 33c, 33d. Instead, the VMs 41, 42, 43, 44 directly controls the I/O devices 51, 52, 53, 54, respectively. Furthermore, the resources in embodiment 1 are assigned to the activated VM 41 (42, 43 or 44). On the other hand, the resources in embodiment 2 are assigned to pre-activated VM 41 (42, 43 or 44).

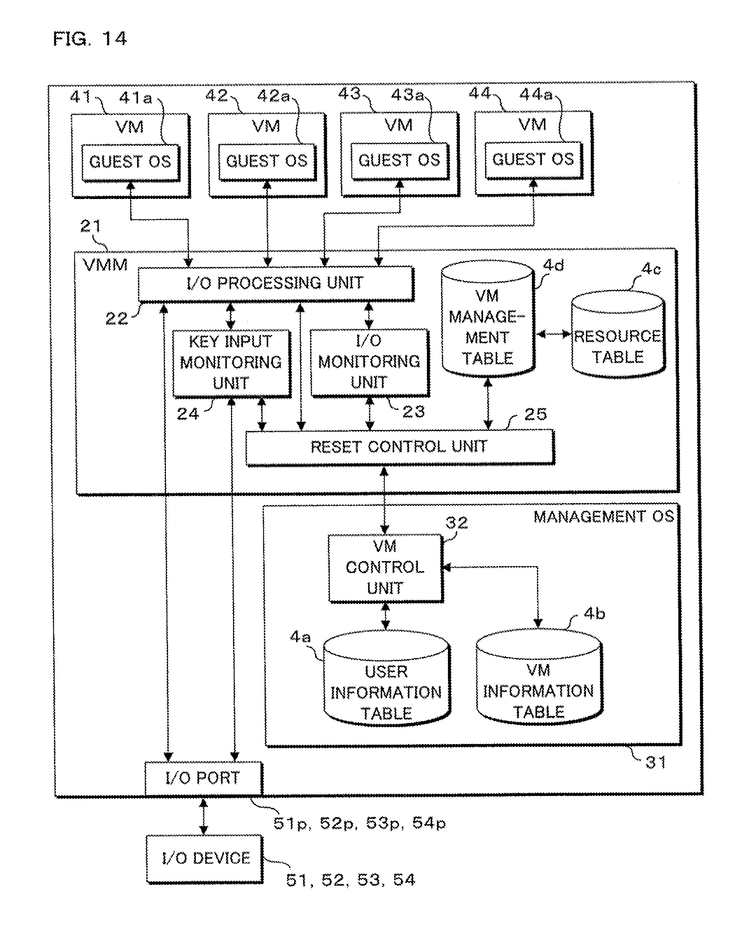

FIG. 14 is a schematic view illustrating configurations of PC according to embodiment 2.

The management OS 31 in embodiment 2 includes the function of the VM control unit 32, but not the functions of the device emulators 33a, 33b, 33c, 33d in embodiment 1. Thus, the input data from the I/O port 51p (52p, 53p or 54p) is transmitted through the I/O processing unit 22 to the VM 41 (42, 43 or 44). In addition, the data generated by the VM 41 (42, 43 or 44) is transmitted through the I/O processing unit 22 to the I/O port 51p (52p, 53p or 54p).

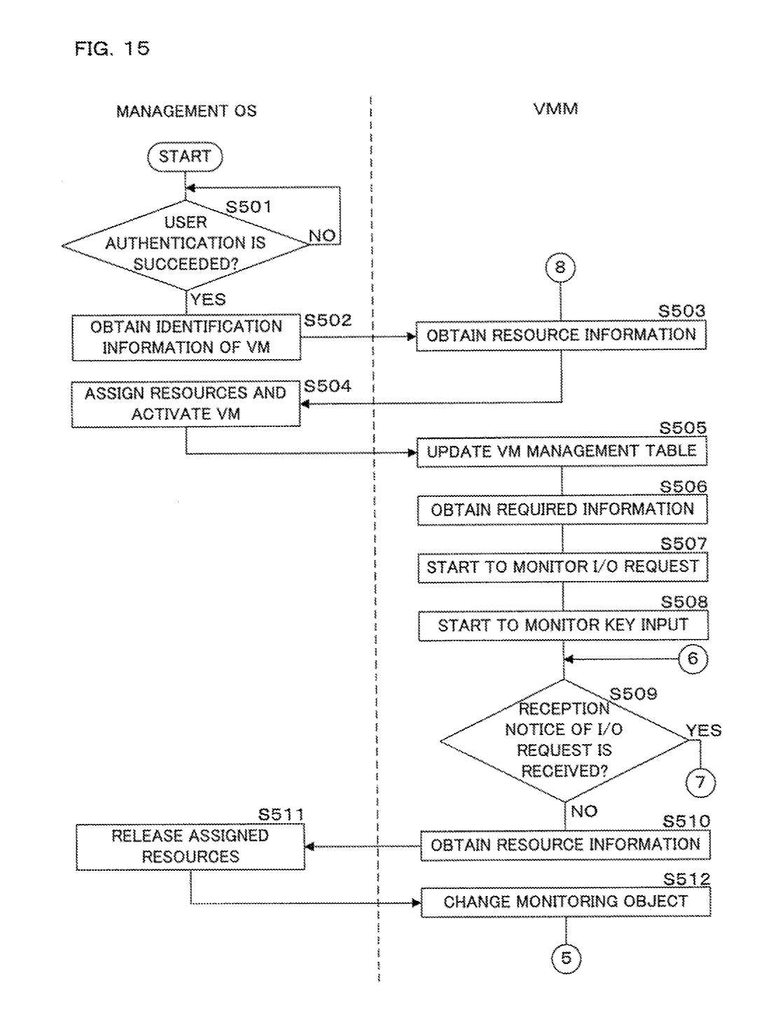

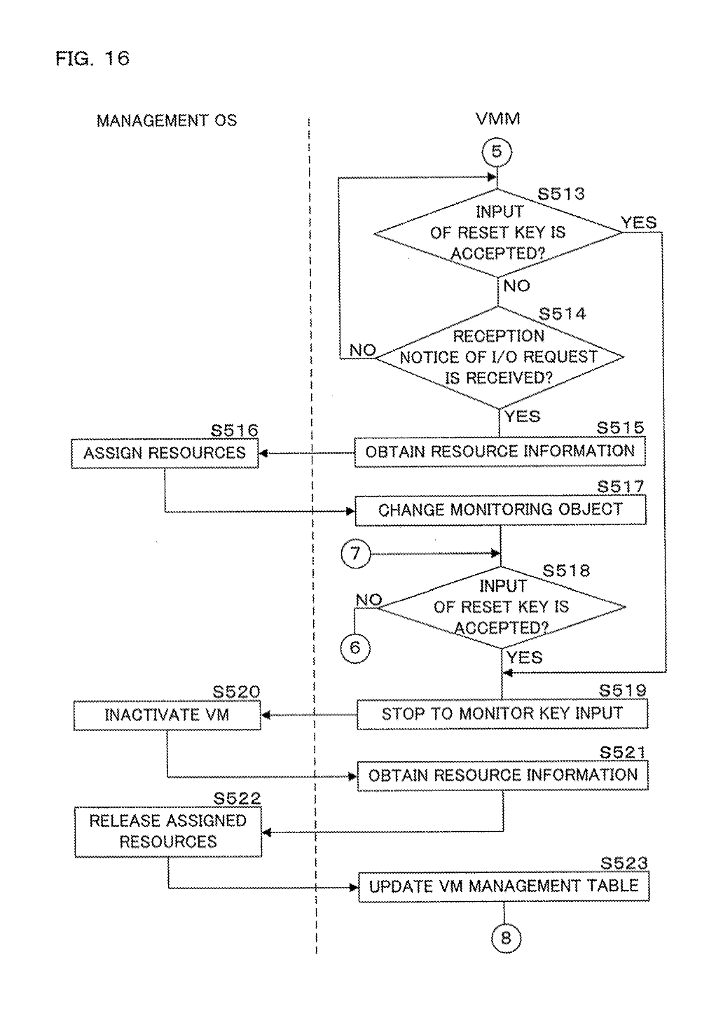

FIG. 15 and FIG. 16 are flowcharts illustrating procedures performed by the VMM 21 and the management OS 31 according to embodiment 2. In FIG. 15 and FIG. 16, there are two regions separated by broken line. The left region illustrates processes performed by the management OS 31, and the right region illustrates processes performed by the VMM 21.

After the PC 10 is turned on and each hardware unit of the PC 10 is activated, the CPU 1 executes the VMM program 20 and works as the VMM 21. After starting to work as the VMM 21, the CPU 1 executes the management OS program 30 and works as the management OS 31.

The VM control unit 32 of the management OS 31 performs the user authentication and determines whether the user authentication has been succeeded or not (S501). When the user authentication has not been succeeded (S501: NO), the VM control unit 32 repeats the user authentication until succeeding. When the user authentication has been succeeded (S501: YES), the VM control unit 32 obtains the VM-ID corresponding to the user information input for the user authentication (S502). The VM control unit 32 transmits both the obtained VM-ID and the request notice of the resource information to the VMM 21.

The reset control unit 25 of the VMM 21 obtains the resource information about resources assigned to the VM 41 from the VM management table 4d, in accordance with the received VM-ID (S503). The reset control unit 25 transmits the obtained resource information to the VM control unit 32. The VM control unit 32 assigns resources based on the resource information to the VM 41 and then activates the VM 41 (S504). After activating the VM 41, the VM control unit 32 transmits the completion notice of activation instruction to the reset control unit 25.

The reset control unit 25 of the VMM 21 updates the VM management table 4d (S505), and obtains the required information from the VM management table 4d (S506). For example, the reset control unit 25 updates the operation status of the VM 41, from the “inactive” to the “active”. Then, the reset control unit 25 obtains monitoring I/O port information corresponding to the VM 41.

The reset control unit 25 of the VMM 21 starts monitoring the I/O request (S507) and the key input (S508), in accordance with the obtained monitoring I/O port information. Then, the I/O processing unit 22 starts transmitting the reception notice of I/O request to the I/O monitoring unit 23 and starts transmitting the copied data of the input key information input from the I/O device 51 toward the key input monitoring unit 24.

The I/O monitoring unit 23 of the VMM 21 determines whether the reception notice of I/O request is received from the I/O processing unit 22 or not (S509). When the reception notice of I/O request is received continuously (S509: YES), the key input monitoring unit 24 performs the process at S518. When no reception notice of I/O request is received (S509: NO), the I/O monitoring unit 23 assumes that the VM 41 is abnormally paused and the VMM 21 starts processing for changing the monitoring object for the key input of the key input monitoring unit 24. At that time, the key input monitoring unit 24 sets the I/O processing unit 22 as the monitoring object for the key input.

The reset control unit 25 of the VMM 21 obtains the resource information about resources assigned to the VM 41 from the VM management table 4d (S510), and transmits both the obtained resource information and the release request notice of assigned resources toward the VM control unit 32. After receiving the release request notice of assigned resources, the VM control unit 32 releases the resources assigned to the VM 41, in accordance with the resource information (S511). After completing the releasing processing of the assigned resources, the VM control unit 32 transmits the completion notice of releasing assigned resources toward the reset control unit 25 of the VMM 21. After receiving the completion notice of releasing assigned resources, the reset control unit 25 of the VMM 21 transmits the change notice containing monitoring object information for identifying the I/O port 51p toward the key input monitoring unit 24. Then, the key input monitoring unit 24 changes to set the I/O port 51p as the monitoring object (S512).

The key input monitoring unit 24 of the VMM 21 determines whether the input key information obtained from the I/O port 51p by the key input monitoring unit 24 represents the reset instruction or not (S513). When the input key information does not represent the reset instruction (S513: NO), the I/O monitoring unit 23 determines whether the reception notice of I/O request has been received from the I/O processing unit 22 or not (S514). When the reception notice of I/O request has not been received (S514: NO), the I/O monitoring unit 23 assumes that the VM 41 is still abnormally paused. Then, the key input monitoring unit 24 performs the process at S513.

When the reception notice of I/O request has been received (S514: YES), the I/O monitoring unit 23 assumes that the VM 41 recovers from the abnormal pausing and the VMM 21 starts the processing for changing the monitoring object for the key input of the key input monitoring unit 24, from the I/O port 51p to the I/O processing unit 22, again. The reset control unit 25 obtains resource information of the VM 41 from the VM management table 4d (S515), and transmits both the obtained resource information and the request notice of resource assignment toward the VM control unit 32 of the management OS 31. After receiving the request notice of resource assignment, the VM control unit 32 of the management OS 31 assigns the resources to the VM 41 based on the received resource information (S516). After completing the resource assignment, the VM control unit 32 transmits the completion notice of resource assignment to the reset control unit 25. After receiving the completion notice of resource assignment, the reset control unit 25 of the VMM 21 transmits the change notice containing monitoring object information for identifying the I/O processing unit 22 toward the key input monitoring unit24. Then, the key input monitoring unit 24 changes to set the I/O processing unit 22 as the monitoring object for key input (S517).

The VMM 21 determines whether the input key information obtained from the I/O processing unit 22 by the key input monitoring unit 24 represents the reset instruction or not (S518). When the input key information does not represent the reset instruction (S518: NO), the I/O monitoring unit 23 determines whether the reception notice of I/O request has been received from the I/O processing unit 22 or not (S509). When the input key information represents the reset instruction (S518: YES), the key input monitoring unit 24 transmits the input notice of reset instruction to the reset control unit 25 and stops monitoring the key input (S519). After receiving the input notice of reset instruction, the reset control unit 25 transmits the reset request notice of the VM to the VM control unit 32 of the management OS 31. Even when the key input monitoring unit 24 has obtained the input key information from the I/O port 51p at the S513 and then it has been determined whether the obtained input key information represents the reset instruction or not (S513: YES), the key input monitoring unit 24 performs the process at S519.

After receiving the reset request notice, the VM control unit 32 of the management OS 31 inactivates the VM 41 (S520) and transmits the reset completion notice to the reset control unit 25 of the VMM 21. After receiving the reset completion notice, the reset control unit 25 of the VMM 21 obtains the resource information of the inactivated VM 41 from the VM management table 4d (S521). Then, the reset control unit 25 transmits both the obtained resource information and the release request notice of assigned resources toward the VM control unit 32 of the management OS 31.

After receiving the release request notice of assigned resources, the VM control unit 32 of the management OS 31 releases the resources assigned to the VM 41 in accordance with the resource information (S522). After completing the releasing processing of the assigned resources, the VM control unit 32 transmits the completion notice of releasing assigned resources to the reset control unit 25 of the VMM 21.

After receiving the completion notice of releasing assigned resources, the reset control unit 25 of the VMM 21 updates the VM management table 4d (S523). Then, the reset control unit 25 performs the procedure from S502 and re-activates the VM 41. Thus, the procedure is completed for the re-activation processing of the abnormally paused VM 41 in response to user's handling of the reset key.

It is possible in embodiment 2, as well as embodiment 1, to reset the abnormally paused VM 41 (42, 43 or 44) from the I/O device 51 (52, 53 or 54) assigned to the abnormally paused VM 41 (42, 43 or 44), as described above. Therefore, it is not required to prepare such a system console dedicated to the reset processing of the PC 10, for resetting the abnormally paused VM 41 (42, 43 or 44).

### Embodiment 3

It will be described below about the PC according to embodiment 3. The PC according to embodiment 3 can be set the manipulation method of the reset key by a user.

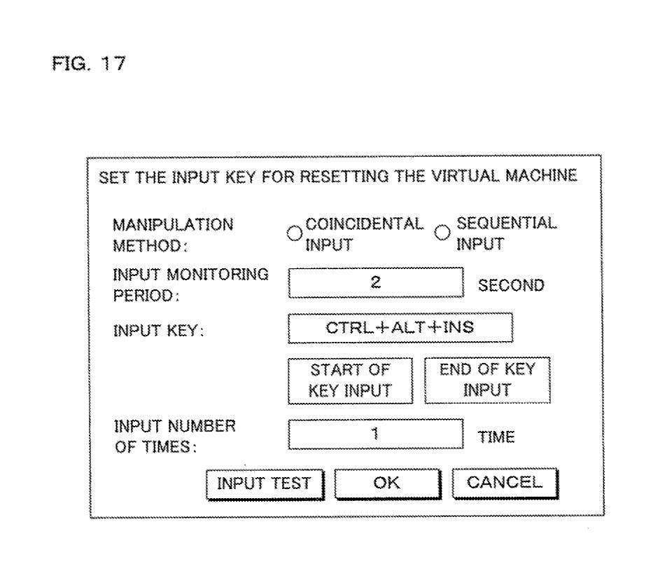

FIG. 17 is a schematic view illustrating an example of display for setting and changing the reset key that introduces the reset processing.

The setting screen illustrated in FIG. 17 is displayed on the monitor display device 51a (52a, 53a or 54a) for setting and changing the reset key that introduces the reset processing. On the setting screen, it is possible to set configuration information about, for example, manipulation method, input monitoring period, input key, input number of times and the like. As for the manipulation method, it is possible to set the combination of keys to be pushed coincidentally or the order of keys to be pushed sequentially on the keyboard 51b (52b, 53b or 54b) for introducing the reset processing. As for the input monitoring period, it is possible to set the monitoring period from the first key push and the last key push. The key manipulation within the set monitoring period is accepted as the manipulation for the reset instruction. As for the input key, it is possible to set keys to be pushed for introducing the reset processing. As for the input number of times, it is possible to set the push number of times for introducing the reset processing.

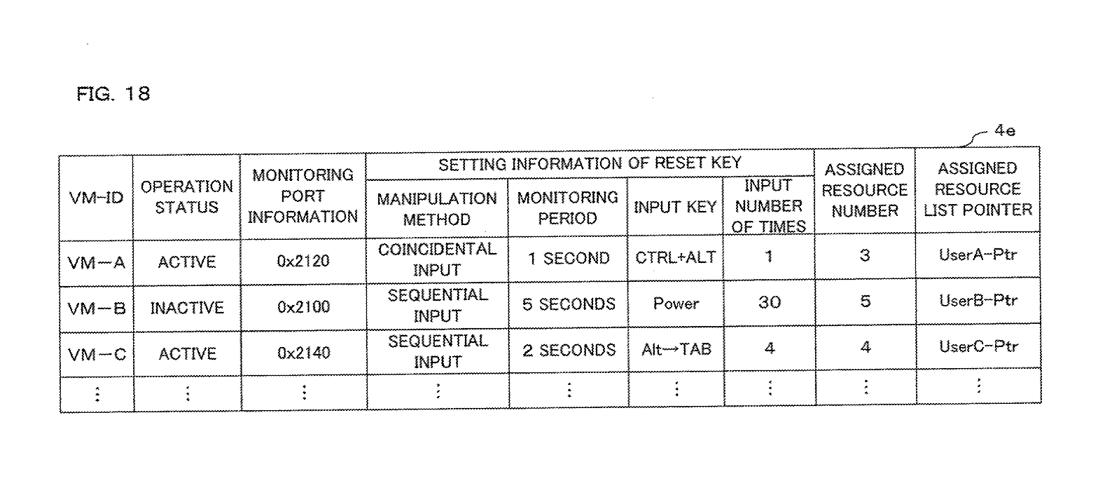

The configuration information is stored in the VM management table 4e. FIG. 18 is a schematic view illustrating contents of VM management table 4e according to embodiment 3. The VM management table 4e stores the configuration information input from the setting screen illustrated in FIG. 17, in addition to the contents of the VM management table 4d according to embodiment 1. Then VM management table 4e may or may not store default values before the configuration information is input from the setting screen.

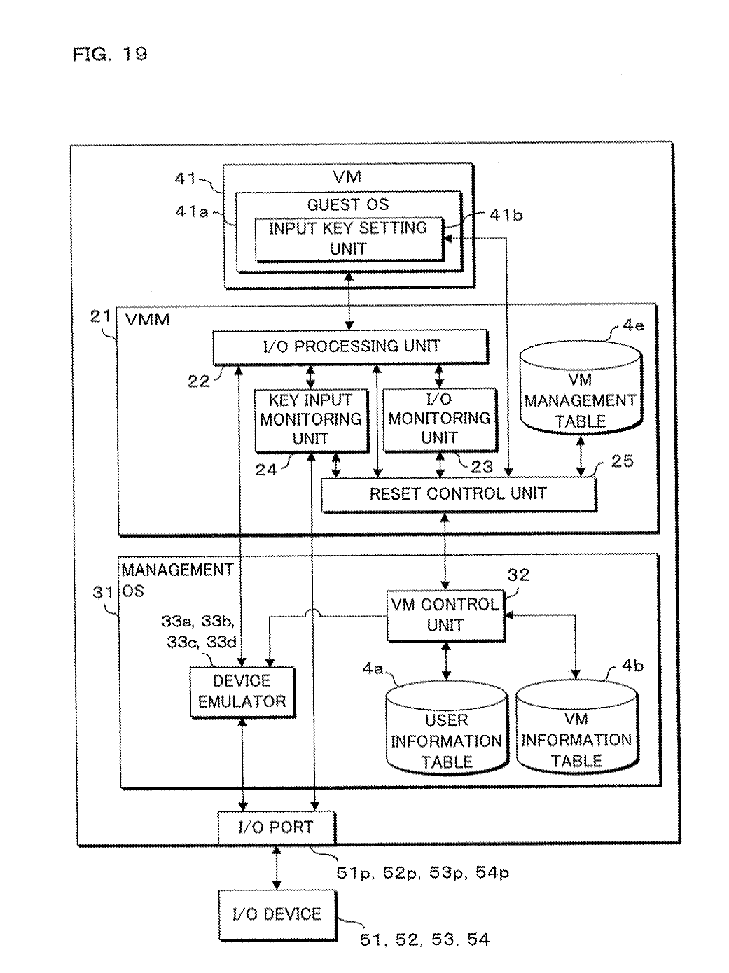

FIG. 19 is a block diagram illustrating functions of PC according to embodiment 3. Although only VM 41 is illustrated in FIG. 19, the other VMs 42, 43, 44 are omitted because all the VMs 41, 42, 43, 44 have similar functions to each other.

In embodiment 3, application is executed for setting about the reset key, and then the guest OS 41a is provided with the function of the input key setting unit 41b. The input key setting unit 41b transmits both the identification information for identifying the VM 41 (VM-ID) and the request notice of reset key configuration information to the reset control unit 25. The request notice of reset key configuration information is for requesting the reset control unit 25 to transmit the configuration information about the reset key. After receiving the request notice of reset key configuration information, the reset control unit 25 obtains the configuration information about the reset key of the VM 41 corresponding to the VM-ID from the VM management table 4e, and transmits the obtained configuration information to the input key setting unit 41b. The input key setting unit 41b makes the monitor display device 51a display the setting screen illustrated in FIG. 17, in accordance with the configuration information about the reset key obtained from the reset control unit 25. Then, the input key setting unit 41b transmits the input configuration information based on the setting screen toward the reset control unit 25.

The reset control unit 25 obtains the configuration information about the reset key from the input key setting unit 41b, and stores in the VM management table 4e. The reset control unit 25 obtains the I/O port information for the input key, the information of the assigned resources and configuration information about the reset key from the VM management table 4e, at the activation time of the VM 41. The reset control unit 25 transmits both the obtained information and the start notice of input monitoring toward the key input monitoring unit 24. In the case of monitoring the input key, the key input monitoring unit 24 determines on the basis of the obtained configuration information about the reset key whether the handled input key is the reset key or not.

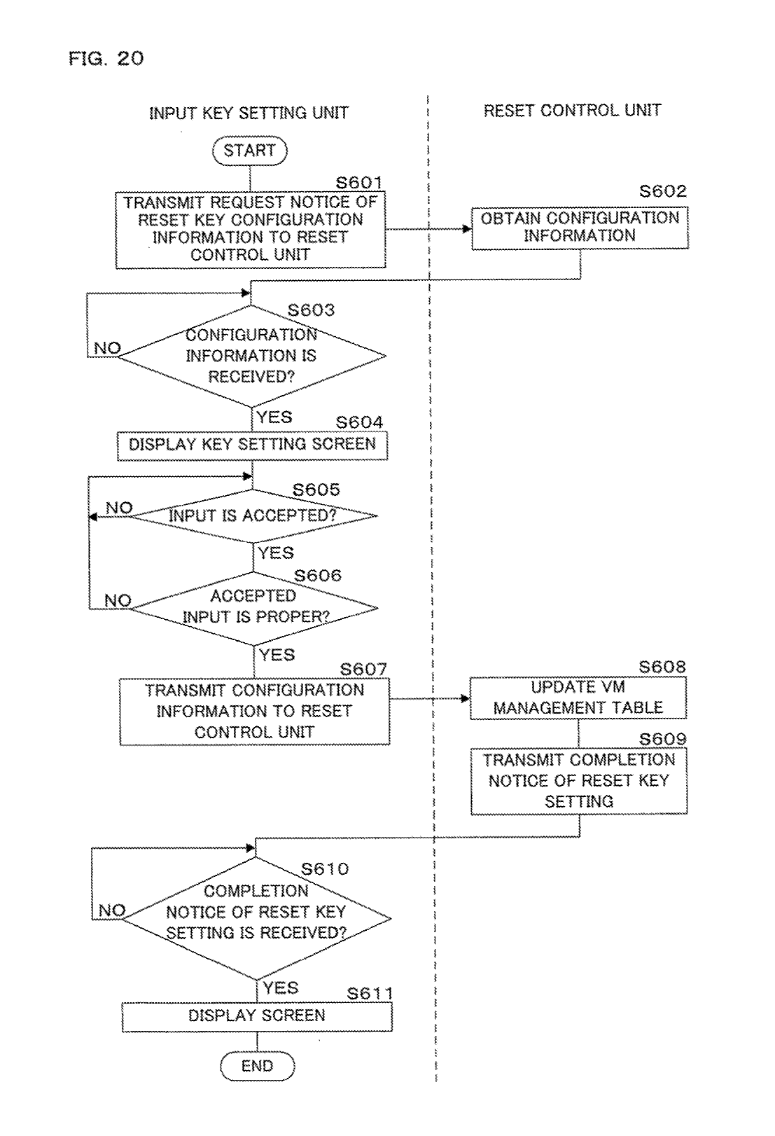

FIG. 20 is a flowchart illustrating a procedure performed by the input key setting unit 41b and the reset control unit 25. The input key setting unit 41b starts the procedure illustrated in FIG. 20 when a user starts application for setting or changing the reset key. In FIG. 20, there are two regions separated by broken line. The left region illustrates processes performed by the input key setting unit 41b, and the right region illustrates processes performed by the reset control unit 25.

The input key setting unit 41b transmits the request notice of reset key configuration information to the reset control unit 25 (S601). After receiving the request notice of reset key configuration information, the reset control unit 25 obtains the configuration information about the reset key from the VM management table 4e (S602) and then transmits the obtained configuration information about the reset key toward the input key setting unit 41b. The input key setting unit 41b determines whether having obtained the transmitted configuration information about the reset key or not (S603). When having determined that the transmitted configuration information about the reset key has not been obtained yet (S603: NO), the input key setting unit 41b waits until obtaining the transmitted configuration information about the reset key.

When having determined that the transmitted configuration information about the reset key has been obtained already (S603: YES), the input key setting unit 41b makes the monitor display device 51a display the input key setting screen based on the obtained configuration information (S604). Next, the input key setting unit 41b determines whether having accepted an input based on the input key setting screen (S605). When having determined that no input has been accepted (S605: NO), the input key setting unit 41b waits until accepting an input. When having determined that an input has been accepted (S605: YES), the input key setting unit 41b further determines whether the accepted input is based on the input key setting screen or not (S606).

When having determined that the accepted input has not been based on the input key setting screen (S606: NO), the input key setting unit 41b re-performs the process at S605. The case that the accepted input has not been based on the input key setting screen is, for example, the case that alphabet is input into the place for number, the case that a user sets a improper key for the system as the reset key, or the like. A message may be displayed for prompting the user to input again, in the case that the input key is not based on the input key setting screen.

When having determined that the accepted input has been based on the input key setting screen (S606: YES), the input key setting unit 41b transmits the input configuration information based on the input key setting screen toward the reset control unit 25 (S607). The reset control unit 25 stores the input key configuration information in the VM management table 4e (S608). Then, the reset control unit 25 transmits the completion notice of reset key setting for notifying the completion of storing in the VM management table 4e (S609).

The input key setting unit 41b determines whether having received the transmitted completion notice of reset key setting or not (S610). When having determined that the transmitted completion notice of reset key setting has not been received yet (S610: NO), the input key setting unit 41b waits until receiving the transmitted completion notice of reset key setting. When having determined that the transmitted completion notice of reset key setting has been received already (S610: YES), the input key setting unit 41b makes the monitor display device 51a display the information about the completion of reset key setting (S611), and then completes the procedure. Although embodiment 3 also has processes for resetting the activated VM 41 (42, 43 or 44) and the like, similar to embodiments 1 and 2, it will not be described about such the similar processes.

As described above, it is possible in embodiment 3 that a user sets and changes the reset key. Therefore, it is possible to properly utilize a password that the user can easily remember for the setting. Furthermore, the setting by each user can lead advantages to prevent unauthorized user from giving improper reset instruction.

### Embodiment 4

It will be described below about the PC according to embodiment 4. In embodiment 4, the I/O device 51 (52, 53 or 54) assigned to the VM 41 (42, 43 or 44) can be utilized for resetting the other VMs 42, 43, 44 (or 41). The following description explains about the case that the VM 42 (43, or 44) is reset by utilizing the I/O device 51 assigned to the VM 41.

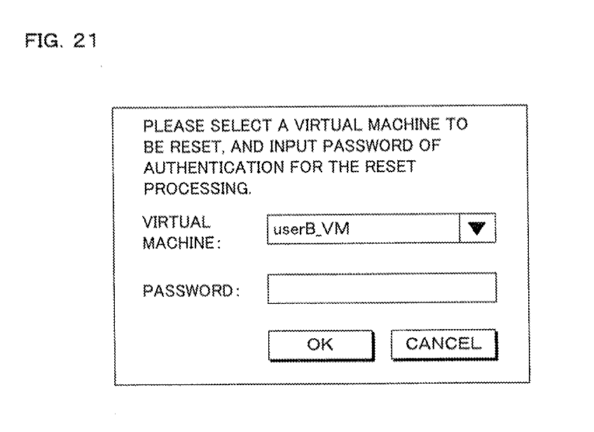

FIG. 21 is a schematic view illustrating an example of authentication screen on monitor display device 51a.

The authentication screen illustrated in FIG. 21 is displayed when the reset key is input through the keyboard 51b assigned to the VM 41. On the authentication screen, there is a selectable name of VM 42 (41, 43 or 44: for example, VM-ID) operating in the PC 10. Furthermore, through the authentication screen, it is possible to input password by utilizing the keyboard 51b. When the name of VM 42 (41, 43 or 44) to be reset is selected and the password is input through the authentication screen which is associated to the selected VM 42 (41, 43 or 44), the selected VM 42 (41, 43 or 44) is allowed to be reset.

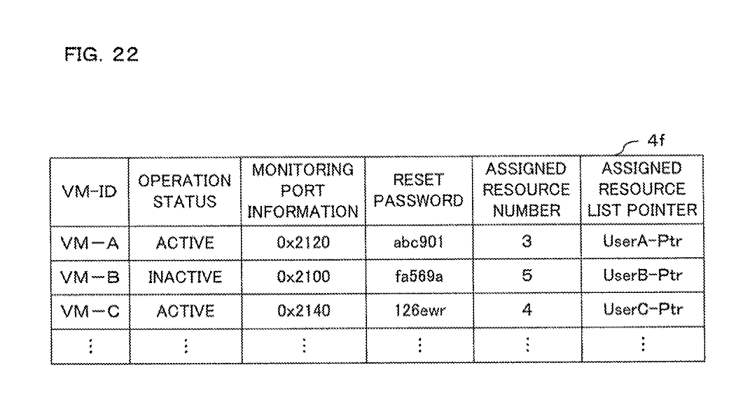

FIG. 22 is a schematic view illustrating contents of VM management table 4f according to embodiment 4. The VM management table 4f stores the reset password in addition to the contents of the VM management table 4d according to embodiment 1. The reset password is associated to the VM 42 (41, 43 or 44) selected through the authentication screen illustrated in FIG. 21.

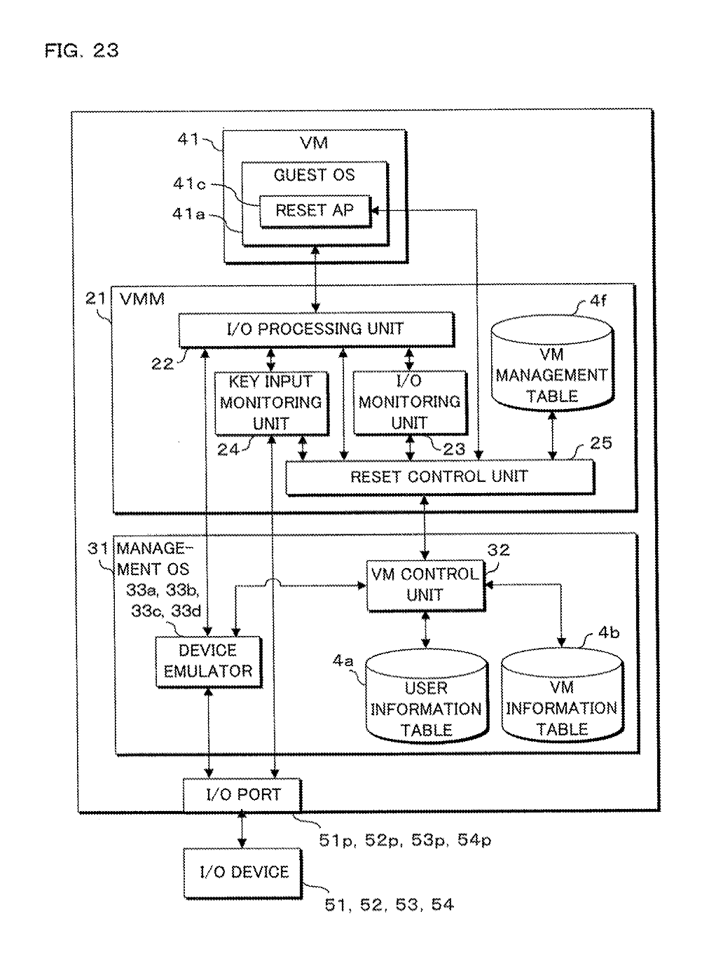

FIG. 23 is a block diagram illustrating functions of PC according to embodiment 4. The VMs 41, 42, 43, 44 have similar functions with each other. Thus, only VM 41 is illustrated on FIG. 23 and the other VMs 42, 43, 44 are omitted. In the guest OS 41a of the VM 41 according to embodiment 4, the reset application (reset AP) 41c is executed. The reset AP 41c is for resetting the activated VM.

When having accepted the reset key input through the keyboard 51b of the VM 41 and having received the input notice of reset instruction from the key input monitoring unit 24, the reset control unit 25 obtains the VM-IDs of all the VM whose operation statuses are “active”, from the VM management table 4f. The reset control unit 25 notifies the VM 41 of the VM-IDs for identifying the activated VMs and instructs to execute the reset AP 41c.

After receiving the execution instruction of the reset AP 41c, the VM 41 allows the guest OS 41a execute the reset AP 41c and makes the monitor display device 51a display the authentication screen illustrated in FIG. 21. At that time, the guest OS 41a shows a list of the activated VM 42 (41, 43 or 44) on the authentication screen. When a user has selected the VM 42 (41, 43 or 44) to be reset and has input proper password based on the authentication screen, the guest OS 41a transmits authentication information about the selected VM and the input password toward the reset control unit 25.

The reset control unit 25 carries out the authentication based on the transmitted authentication information and on another authentication information obtained from the VM management table 4f. The reset control unit 25 identifies the VM 42 (41, 43 or 44) selected through the authentication screen, on the basis of the transmitted authentication information. Then, the reset control unit 25 obtains the reset password associated to the identified VM 42 (41, 43 or 44) from the VM management table 4f. Next, the reset control unit 25 determines on the basis of these authentication information whether the password input through the authentication screen is identical to the reset password obtained from the VM management table 4f or not. When having determined that the input password is identical to the reset password, the reset control unit 25 determines that the authentication is succeeded. When having determined that the authentication is succeeded, the reset control unit 25 starts the reset processing of the VM 42 (41, 43 or 44).

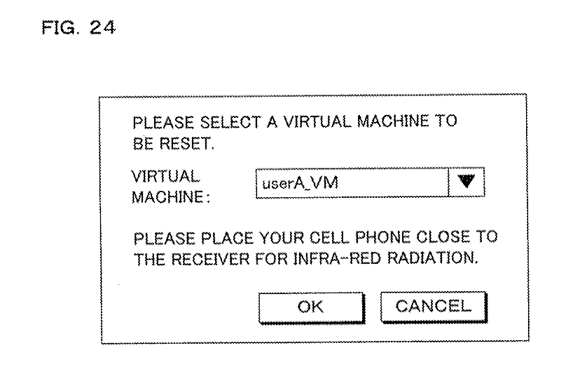

The authentication for resetting may be carried out with utilizing a device owned by a user. For example, the PC 10 may be provided with a receiver for infra-red radiation and a cell phone owned by a user may transmit information (e.g., the user's profile) stored in the cell phone with utilizing the infra-red radiation, in order to carry out the authentication for resetting. FIG. 24 is a schematic view illustrating another example of authentication screen on monitor display device 51a. On the authentication screen illustrated in FIG. 24, the selectable name is displayed for the VM 42 (41, 43 or 44) activated in the PC 10. In addition, a message is displayed on the authentication screen for prompting the transmission of infra-red radiation from the cell phone.

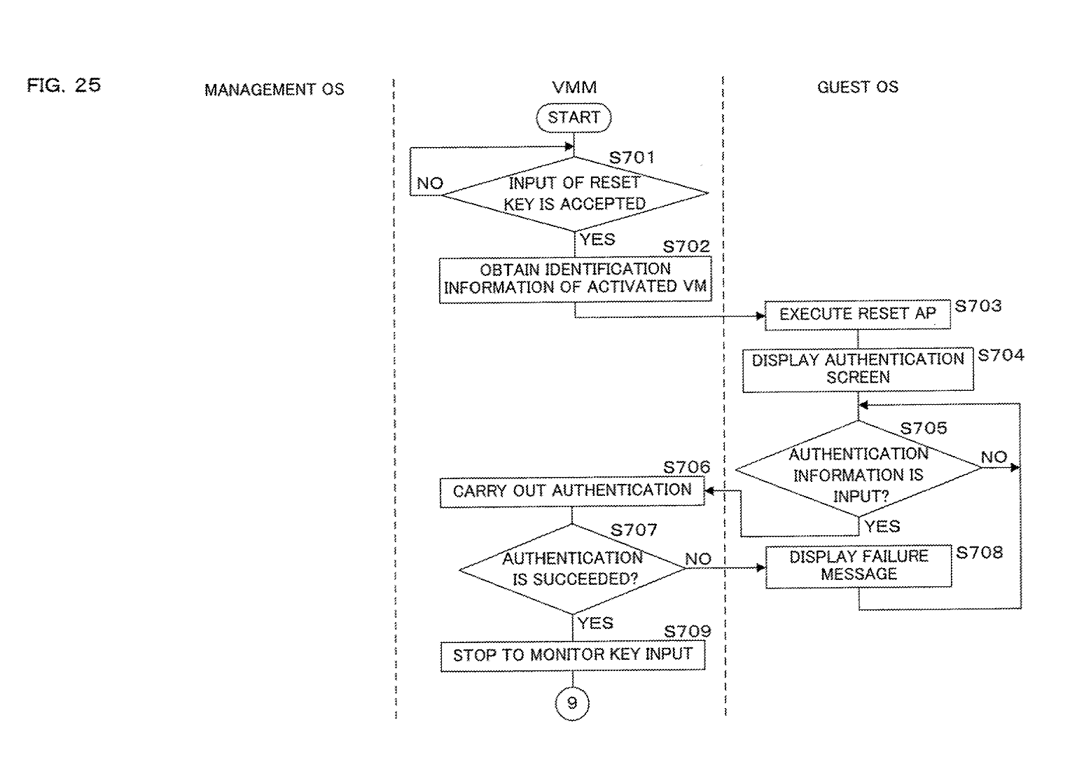

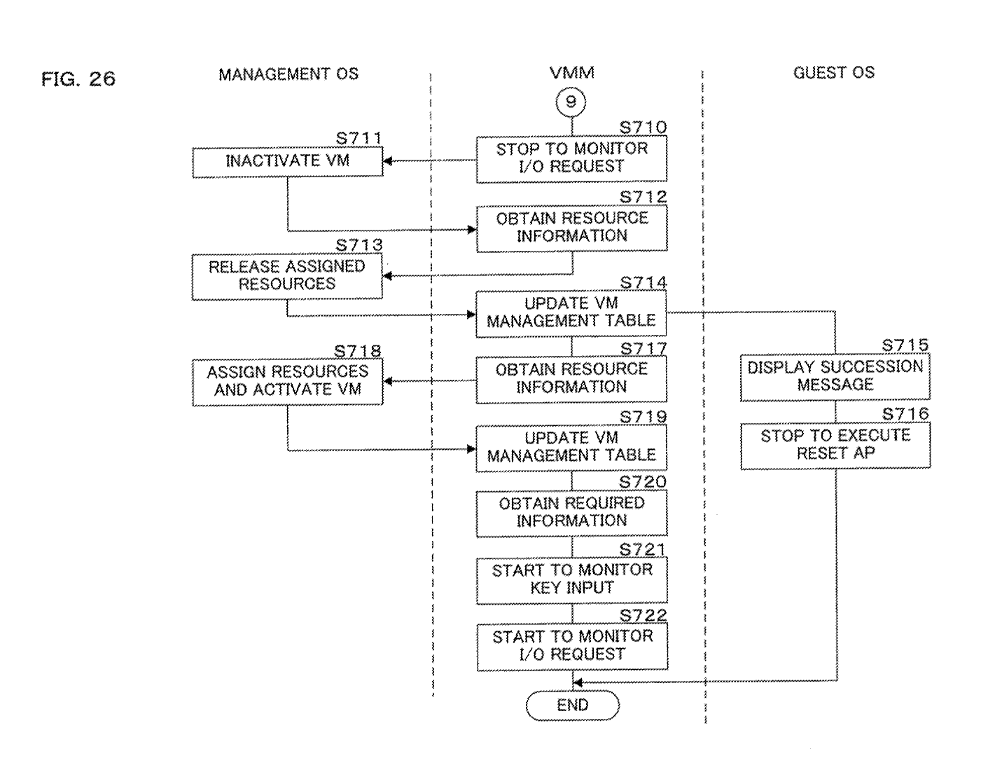

FIG. 25 and FIG. 26 are flowcharts illustrating procedures performed by the VMM 21, the management OS 31 and the guest OS 41a according to embodiment 4. In FIG. 25 and FIG. 26, there are three regions separated by broken line. The left region illustrates processes performed by the management OS 31, the center region illustrates processes performed by the VMM 21, and the right region illustrates processes performed by the guest OS 41a.

The key input monitoring unit 24 of the VMM 21 determines whether the reset key is handled to start the reset processing or not (S701). When having determined that the reset key is not handled yet to start the reset processing (S701: NO), the key input monitoring unit 24 waits until accepting the input through the reset key. When having determined that the reset key is handled to start the reset processing (S701: YES), the key input monitoring unit 24 transmits the input notice of reset instruction to the reset control unit 25. The reset control unit 25 obtains identification information of the activated VM 42 (41, 43 or 44) from the VM management table 4f (S702). Then, the reset control unit 25 notifies the guest OS 41a of the obtained identification information for identifying the VM 42 (41, 43 or 44), and further instructs the guest OS 41a to execute the reset AP 41c.

The guest OS 41a executes the reset AP 41c (S703). The reset AP 41c informs the monitor display device 51a to display the authentication screen (S704). The reset AP 41c determines whether authentication information is input in accordance with the authentication screen or not (S705). When having determined that authentication information is not input in accordance with the authentication screen (S705: NO), the reset AP 41c waits until accepting the input of the authentication information. When having determined that authentication information is input in accordance with the authentication screen (S705: YES), the reset AP 41c transmits the input authentication information to the reset control unit 25.

The reset control unit 25 of the VMM 21 carries out the authentication based on the obtained authentication information (S706). Particularly, the reset control unit 25 identifies the VM 42 (41, 43 or 44) selected through the authentication screen on the basis of the obtained authentication information, and obtains the reset password associated to the identified VM from the VM management table 4f. The reset control unit 25 determines on the basis of the authentication information whether the password input through the authentication screen is identical to the reset password or not.

The reset control unit 25 determines whether the authentication is succeeded or not, on the basis of the determination result whether the input password is identical to the reset password or not (S707). When having determined that the authentication is not succeeded (S707: NO), the reset control unit 25 notifies the reset AP 41c of the authentication failure. Then, the reset AP 41c informs the monitor display device 51a to display a message about the authentication failure (S708). Next, the reset AP 41c performs the process at S705.

When having determined that the authentication is succeeded (S707: YES), the reset control unit 25 stops monitoring the key input on the VM 42 (41, 43 or 44) (S709), and stops monitoring the I/O request (S710). Next, the VM control unit 32 of the management OS 31 inactivates the VM 42 (41, 43 or 44) (S711). The reset control unit 25 of the VMM 21 obtains resource information of the inactivated VM 42 (41, 43 or 44) (S712). The reset control unit 25 transmits both the obtained resource information and the release request notice of assigned resources toward the VM control unit 32 of the management OS 31. After receiving both the obtained resource information and the release request notice of assigned resources, the VM control unit 32 of the management OS 31 releases the resources assigned to the VM 42 (41, 43 or 44) (S713). After completing the resource releasing processing, the VM control unit 32 transmits the completion notice of releasing assigned resources to the reset control unit of the VMM 21. After receiving the completion notice of releasing assigned resources, the reset control unit 25 of the VMM 21 updates the VM management table 4f (S714).

The reset control unit 25 of the VMM 21 notifies the reset AP 41c of the reset completion, and then the reset AP 41c informs the monitor display device 51a to display a message about the success in the reset processing (S715). Then, the guest OS 41a stops executing the reset AP 41c (S716).

The reset control unit 25 of the VMM 21 obtains information of resources assigned to the VM 42 (41, 43 or 44) from the VM management table 4f (S717). The reset control unit 25 transmits the obtained resource information to the management OS 31. The VM control unit 32 of the management OS 31 assigns resources to the VM 42 (41, 43 or 44) based on the transmitted resource information, and activates the VM 42 (41, 43 or 44) (S718). After activating the VM 42 (41, 43 or 44), the VM control unit 32 transmits the completion notice of activation instruction toward the VMM 21.

The reset control unit 25 of the VMM 21 updates the VM management table 4f (S719) and obtains required information from the VM management table 4f (S720). On the basis of the obtained monitoring port information, the reset control unit 25 of the VMM 21 starts monitoring the key input (S721), and then starts monitoring the I/O request (S722). The processing is completed for resetting the VM 42 (41, 43 or 44) through handling the I/O device 51 assigned to the VM 41.

As described above, it is possible in embodiment 4 to give instruction for reset processing of the VM 41 (42, 43 or 44) from the other VMs 42, 43, 44 (or 41). Thus, it is possible 4 to give the instruction for resetting the VM 41 (42, 43 or 44) from the I/O devices 52, 53, 54 (or 51), even in the case that malfunction is caused in the VM 41 (42, 43 or 44) and it is not possible to give the instruction for resetting the VM 41 (42, 43 or 44) from the I/O device 51 (52, 53 or 54).

### Embodiment 5

It will be described below about the PC according to embodiment 5. In embodiment 5, the PC can be connected with a storage medium, such as a USB memory, and the activation of the reset AP explained in embodiment 4 is started in response to the connection of the storage medium.

The PC according to embodiment 5 is provided with USB ports 5a, 5a, . . . for connecting the monitor display devices 51a, 52a, 53a, 54a and with further four USB ports 5a, 5a, . . . . The storage medium to be connected to the USB port 5a stores program for the reset AP and identification information (VM-ID) for identifying the VM 41 (42, 43 or 44). When the storage medium is connected to the USB port 5a, the PC starts processing for resetting the VM 41 (42, 43 or 44) identified by the VM-ID stored in the storage medium.

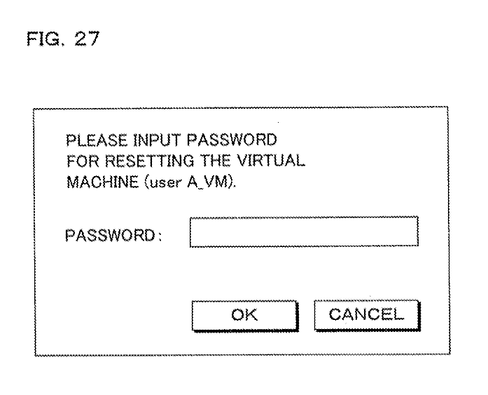

FIG. 27 is a schematic view illustrating an example of the authentication screen on monitor display device 51a (52a, 53a or 54a).

When the storage medium is connected to the USB port 5a, the authentication screen illustrated in FIG. 27 is displayed on the monitor display device 51a (52a, 53a or 54a). Then, a message is displayed on the authentication screen for indicating the reset of the VM 41 (42, 43 or 44) identified by the VM-ID stored in the storage medium. On the authentication screen, the keyboard 51b (52b, 53b or 54b) can be utilized for inputting password. When a password is input in accordance with the authentication screen for identifying the VM 41 (42, 43 or 44), the reset processing is started of the VM 41 (42, 43 or 44).

A USB port 5a to be connected to such the storage medium is assigned to each of the VMs 41, 42, 43, 44. When the storage medium is connected to the PC, it is identified which VM among the VMs 41, 42, 43, 44 is assigned with the USB port 5a connected to the storage medium. The authentication screen illustrated in FIG. 27 is displayed on the monitor display device 51a (52a, 53a or 54a) of the identified VM 41 (42, 43 or 44).

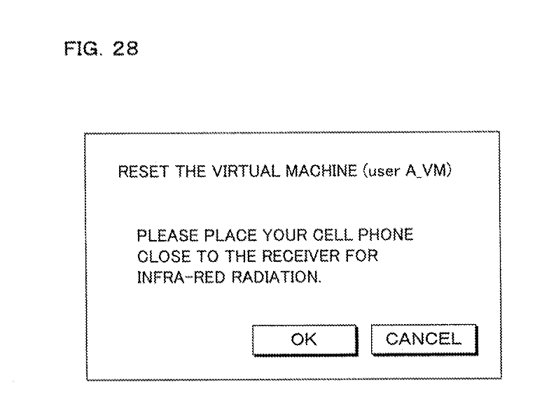

The authentication for starting the reset processing may require a device owned by a user instead of password input by a user, similarly to embodiment 4. FIG. 28 is a schematic view illustrating another example of authentication screen on monitor display device 51a (52a, 53a or 54a). As illustrated in FIG. 28, a message is displayed on the authentication screen for prompting the transmission of infra-red radiation from the cell phone.

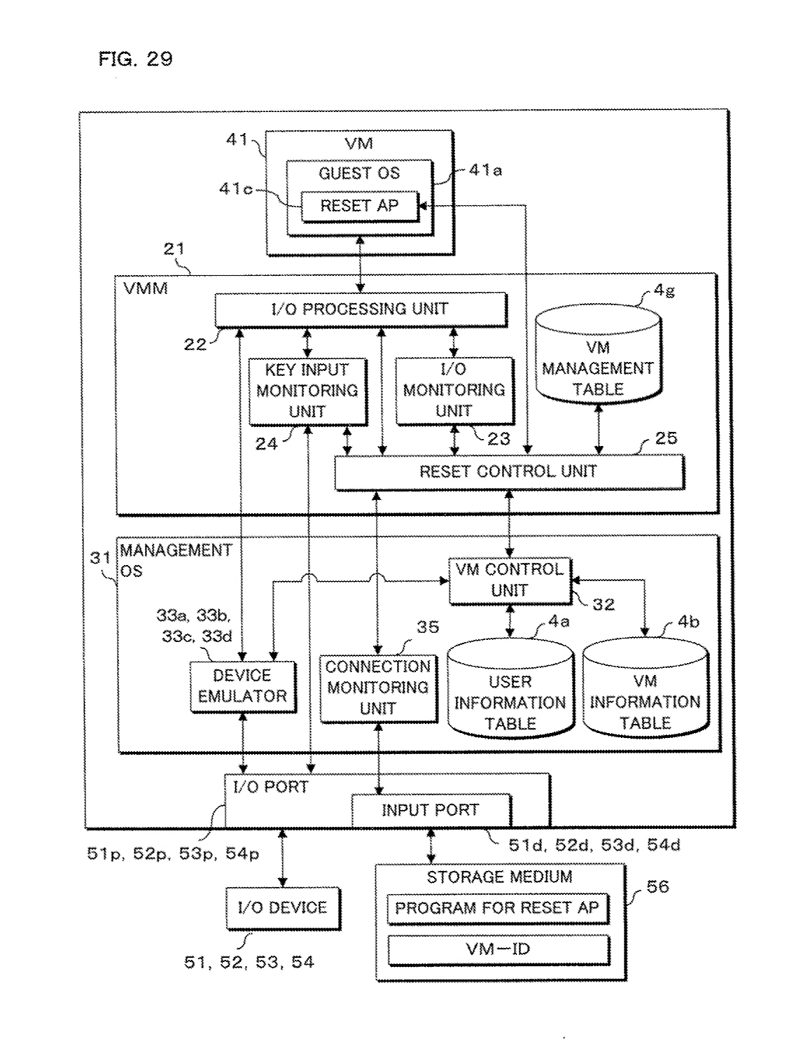

FIG. 29 is a block diagram illustrating functions of PC according to embodiment 5. The VMs 41, 42, 43, 44 have similar functions with each other. Thus, only VM 41 is illustrated on FIG. 29 and the other VMs 42, 43, 44 are omitted.

The I/O ports 51p, 52p, 53p, 54p in embodiment 5 includes input ports (connecting means) 51d, 52d, 53d, 54d, respectively. To the input ports 51d, 52d, 53d, 54d, it is possible to connect the storage medium 56, such as the USB memory. The storage medium 56 stores program for the reset AP and identification information (VM-ID) for identifying the VM 41 (42, 43 or 44).

The management OS 31 is further provided with a function as the connection monitoring unit 35. The connection monitoring unit 35 monitors a connection at the input ports 51d, 52d, 53d, 54d. When the storage medium 56 is connected to the input port, the connection monitoring unit 35 obtains port information of the input port connected with the storage medium 56. The port information is for identifying the input ports 51d, 52d, 53d, 54d. The connection monitoring unit 35 notifies the reset control unit 25 of both the obtained port information and the request notice of input port assignment.

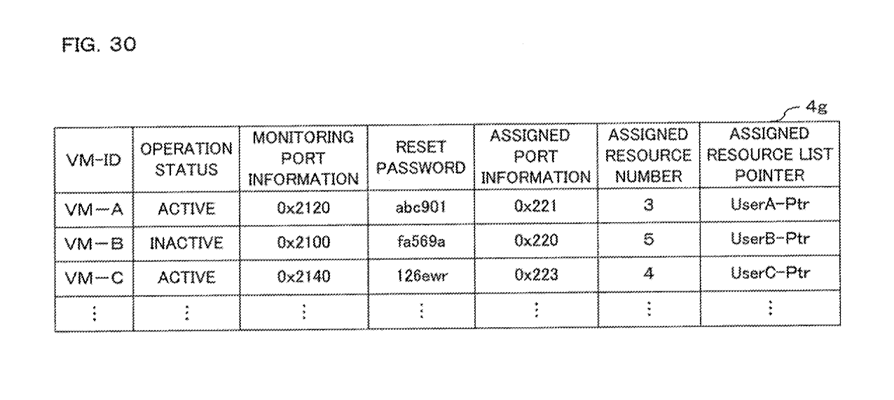

After receiving the request notice of input port assignment, the reset control unit 25 identifies a VM corresponding to the port information among the VMs 41, 42, 43, 44 based on the VM management table 4g. FIG. 30 is a schematic view illustrating contents of the VM management table 4g according to embodiment 5. The VM management table 4g stores the assigned port information in addition to the contents of the VM management table 4f according to embodiment 4. The assigned port information is for identifying the input ports 51d, 52d, 53d, 54d. The reset control unit 25 identifies the VM 41 (42, 43 or 44) based on the port information obtained from the connection monitoring unit 35. Then, the reset control unit 25 transmits the information about the identified VM 41 (42, 43 or 44), the port information and the request notice of input port assignment toward the VM control unit 32.

The VM control unit 32 assigns, to the VM 41 (42, 43 or 44), the input port 51d (52d, 53d or 54d) connected with the storage medium 56. After provided the assignment by the VM control unit 32, the VM 41 (42, 43 or 44) reads out the program for the reset AP stored in the storage medium 56, and executes the reset AP 41c on the guest OS 41a (42a, 43a or 44a). The reset AP 41c on the guest OS 41a is the reset AP program read out from the storage medium 56.

After executing the reset AP 41c, the guest OS 41a reads out the VM-ID from the storage medium 56 and identifies the VM 42 (41, 43 or 44) to be reset. Then, the reset AP 41c activated on the guest OS 41a (42a, 43a or 44a) informs the monitor display device 51a (52a, 53a or 53a) to display the authentication screen. The reset AP 41c transmits the password input through the authentication screen toward the reset control unit 25. The reset control unit 25 then performs the authentication for starting the reset processing, similarly to embodiment 4.

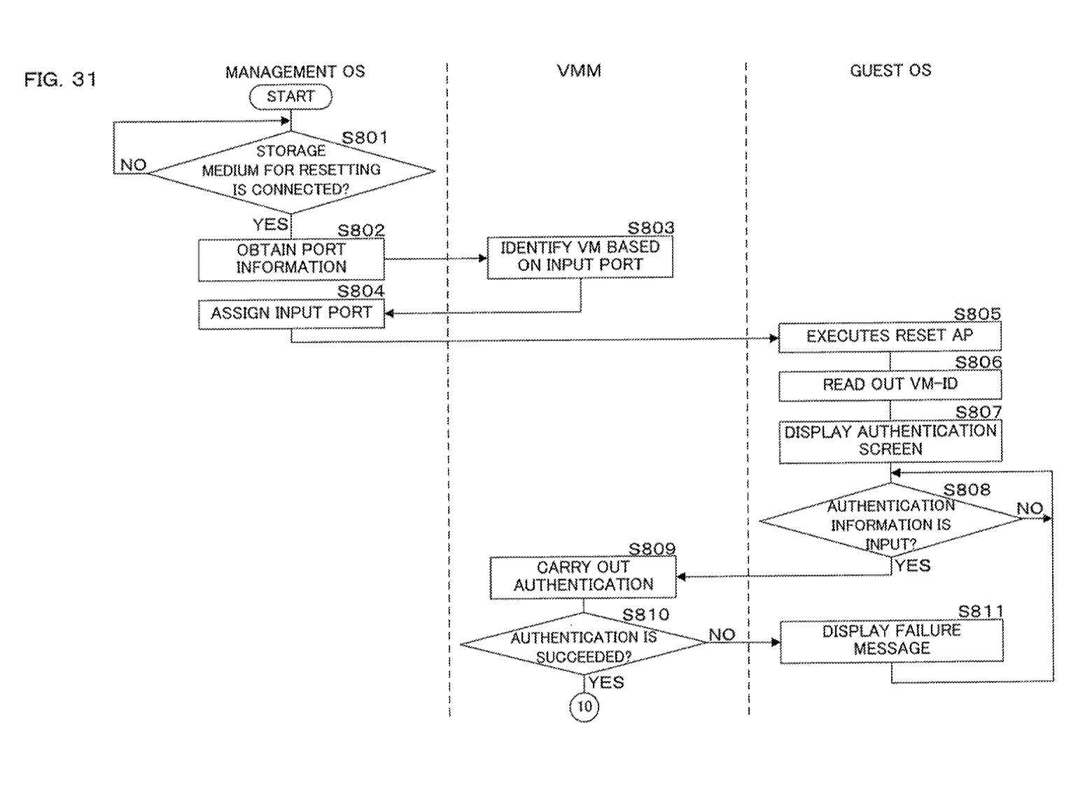

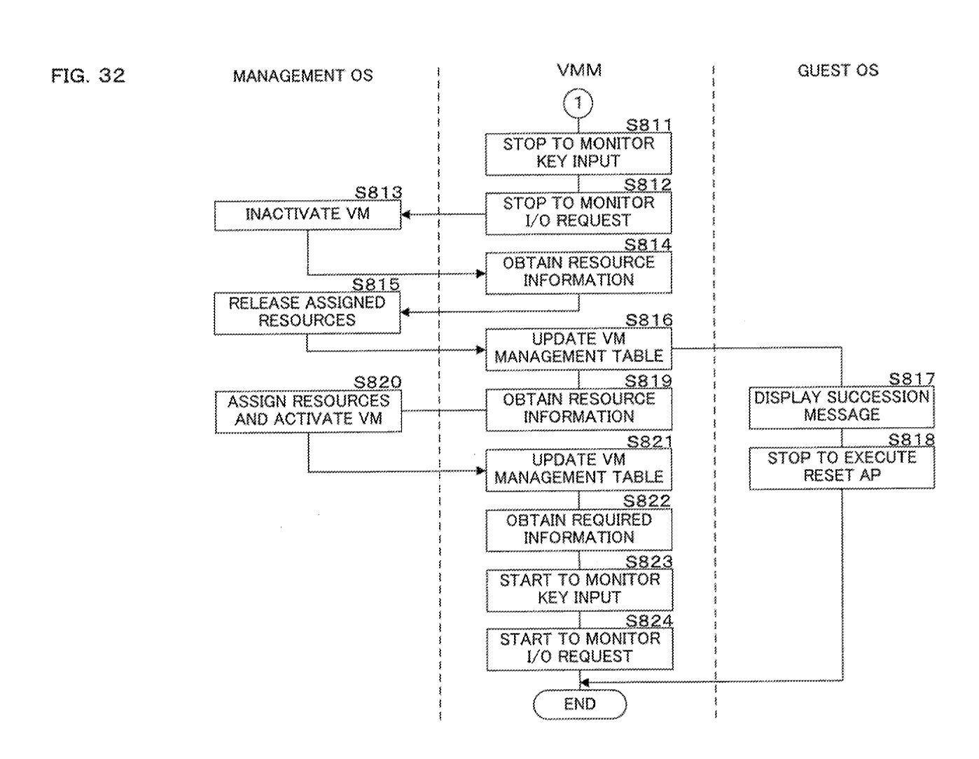

FIG. 31 and FIG. 32 are flowcharts illustrating procedures performed by the VMM 21, the management OS 31 and the guest OS 41a (42a, 43a or 44a) according to embodiment 5

The connection monitoring unit 35 of the management OS 31 determines whether the storage medium 56 for resetting is connected to the input port 51d (52d, 53d or 54d) or not (S801). The storage medium 56 for resetting stores program for the reset AP and the identification information for identifying the VM 42 (41, 43 or 44). When having determines that the storage medium 56 for resetting is not connected (S801: NO), the connection monitoring unit 35 waits until that the storage medium 56 for resetting is connected. When having determines that the storage medium 56 for resetting is connected (S801: YES), the connection monitoring unit 35 obtains port information of the input port 51d (52d, 53d or 54d) connected with the storage medium 56 (S802). Then, the connection monitoring unit 35 notifies the reset control unit 25 of both the obtained port information and the request notice of input port assignment.

The reset control unit 25 of the VMM 21 identifies the VM 41 (42, 43 or 44) based on the port information in accordance with the VM management table 4g (S803). Then, the reset control unit 25 notifies the VM control unit 32 of both the information about the identified VM 41 (42, 43 or 44) and the port information together with the request notice of input port assignment. The VM control unit 32 of the management OS 31 assigns, to the VM 41 (42, 43 or 44), the input port 51d (52d, 53d or 54d) connected with the storage medium 56 (S804).

After assigned with the input port by the VM control unit 32, the VM 41 (42, 43 or 44) reads out the program for the reset AP stored on the storage medium 56, and then executes the reset AP on the guest OS 41a (42a, 43a or 44a) (S805). The reset AP 41c activated on the guest OS 41a (42a, 43a or 44a) reads out the VM-ID from the storage medium 56 (S806). Thus, the reset AP 41c identifies the VM 42 (41, 43 or 44) to be reset. Then, the reset AP 41c informs the monitor display device 51a (52a, 53a or 54a) to display the authentication screen (S807). The processes followed by S808 are similar to the processes followed by the S705 illustrated in FIG. 25, and thus the explanation is omitted.

As described above, the connection of the storage medium 56 in embodiment 5 can start the reset processing of the VM 42 (41, 43 or 44). Therefore, it is possible to prevent unauthorized user who does not have the storage medium 56 from arbitrary starting the reset processing.

It should be noted that the storage medium 56 is not limited to the USB memory, although embodiment 5 is explained with the USB memory as the storage medium 56. For example, a Compact Disc (CD) or a Digital Video Disc (DVD) may be inserted into the PC, the PC can automatically read out storage data from the inserted CD or DVD, and then the reset processing described above may be started.

### Embodiment 6

It will be described below about the PC according to embodiment 6. In embodiment 6, the VMs 41, 42, 43, 44 are shut down forcibly, in the case that malfunction is caused on the VMs 41, 42, 43, 44 during the inactivation processing, the VMs 41, 42, 43, 44 are not inactivated properly and then the input of the reset key is accepted.

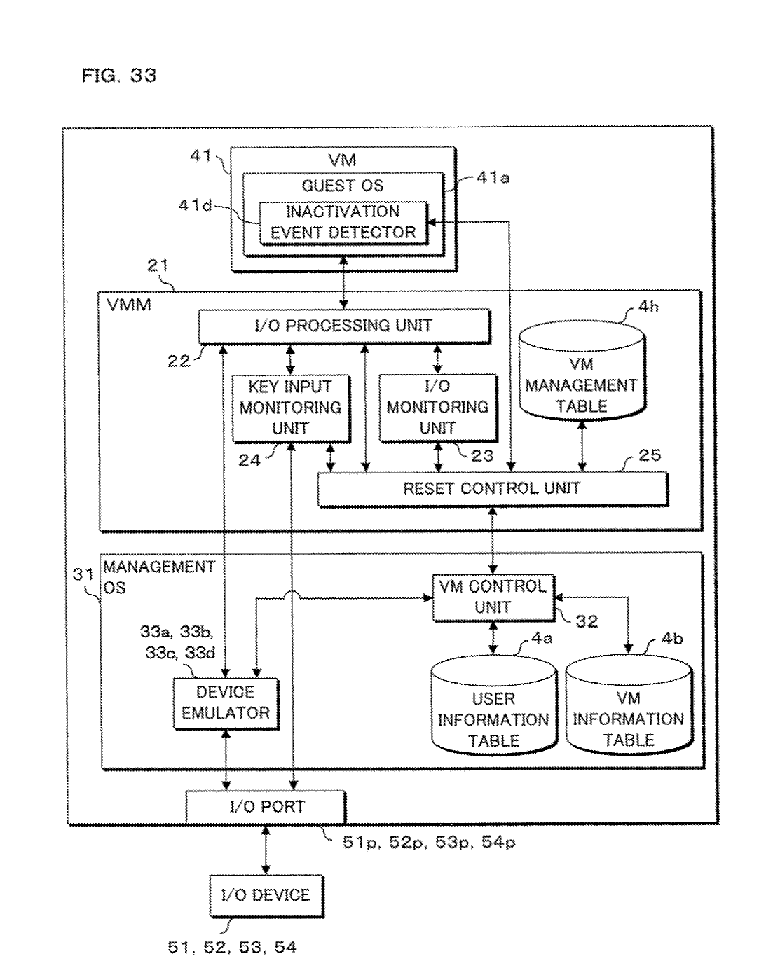

FIG. 33 is a block diagram illustrating functions of PC according to embodiment 6. The VMs 41, 42, 43, 44 have similar functions and performs similar processes with each other. Thus, only VM 41 is illustrated on FIG. 33 and explained in detail, but the other VMs 42, 43, 44 are omitted.

The guest OS 41a in embodiment 6 is provided with a function as the inactivation event detector 41d. The inactivation event detector 41d detects the inactivation event for inactivating the VM 41. The inactivation event is an operation at the beginning in response to, for example, an inactivation operation input by a user or an inactivation instruction generated by application. When having detected such the inactivation event, the inactivation event detector 41d notifies the reset control unit 25 of the result detecting the inactivation event.

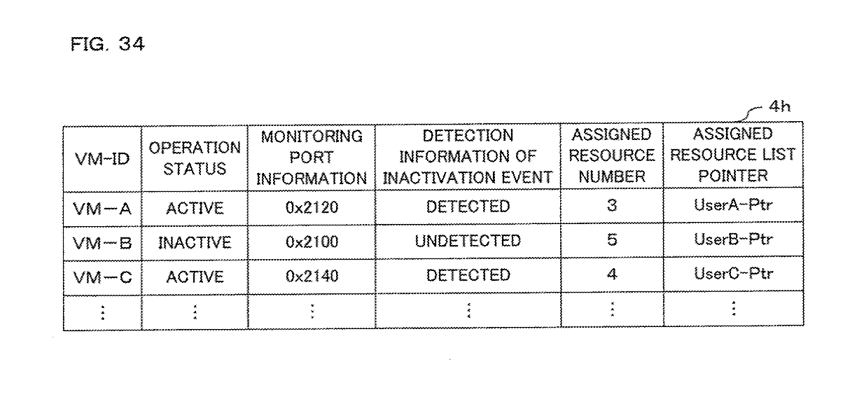

When having been notified of the result detecting the inactivation event by the inactivation event detector 41d, the reset control unit 25 updates the detection information of the inactivation event stored in the VM management table 4h. FIG. 34 is a schematic view illustrating contents of the VM management table 4h according to embodiment 6. The VM management table 4h stores the detection information of the inactivation event in addition to the contents of the VM management table 4d according to embodiment 1. The detection information of the inactivation event contains information about whether the inactivation event detector 41d detects the inactivation event or not. When having been notified of the result detecting the inactivation event by the inactivation event detector 41d, the reset control unit 25 sets the status of the inactivation event detection information to be “detected”. When having been notified of the result un-detecting the inactivation event by the inactivation event detector 41d, the reset control unit 25 sets the status of the inactivation event detection information to be “undetected”.

When the VM 41 has been inactivated by the reset processing in response to the input of the reset key and the reset control unit 25 has transmitted the request notice of releasing the assigned resources toward the VM control unit 32 and then has received the completion notice of releasing assigned resources from the VM control unit 32, the reset control unit 25 determines whether the status is “undetected” or not in reference to the inactivation event detection information on the VM management table 4h. When the status of the inactivation event detection information has been determined to be “detected”, the reset control unit 25 decides that the input of the reset key is accepted during the inactivation processing of the VM 41 and inhibits activation processing of the VM 41. When the status of the inactivation event detection information is determined to be “undetected”, the reset control unit 25 decides that the input of the reset key is accepted not during the inactivation processing of the VM 41 and transmits the activation instruction to the VM control unit 32 in order to activate the VM 41. Therefore, it is possible to inactivate the VM 41 in the case that the reset instruction is input during the inactivation processing of the VM 41, and to re-activate the VM 41 in the case that the reset instruction is input during properly operating the VM 41 (except for the inactivation processing).

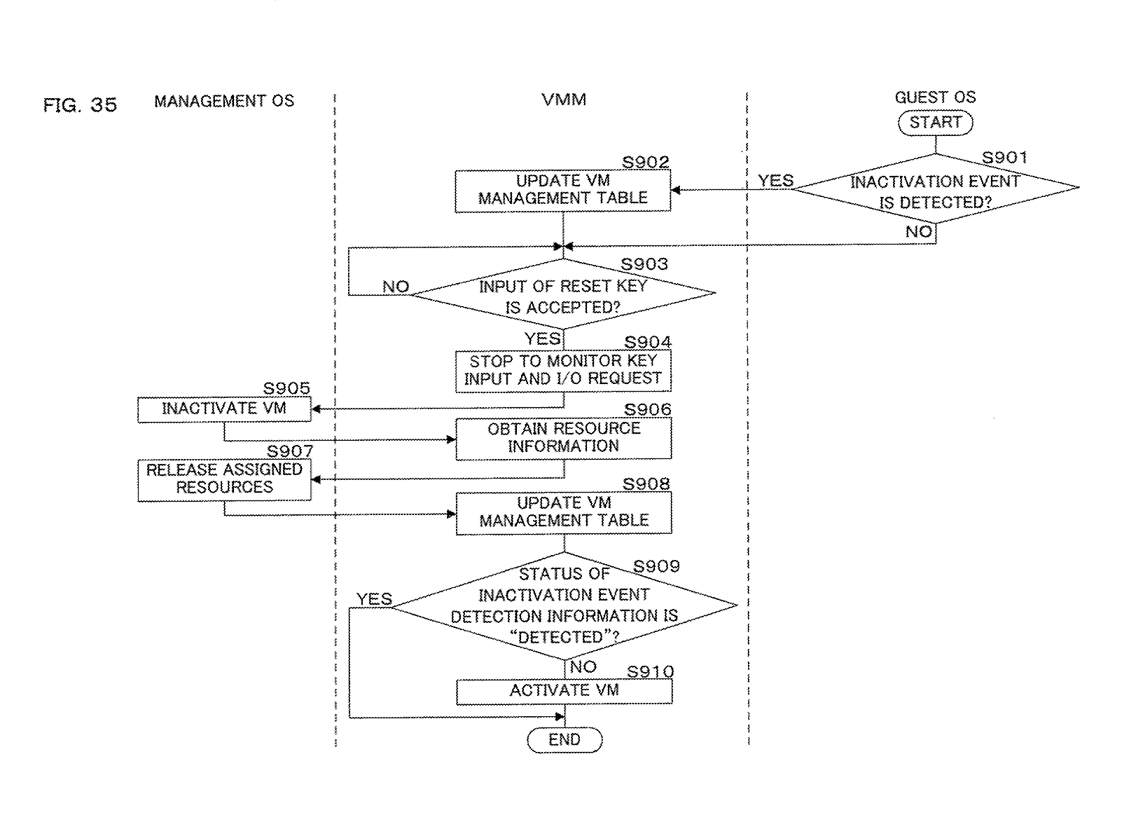

FIG. 35 is a flowchart illustrating a procedure performed by the VMM 21, the management OS 31 and the guest OS 41a according to embodiment 6. In FIG. 35, there are three regions separated by broken line. The left region illustrates processes performed by the management OS 31, the center region illustrates processes performed by the VMM 21, and the right region illustrates processes performed by the guest OS 41a.

The inactivation event detector 41d of the guest OS 41a determines whether having detected the inactivation event or not (S901). When having determined that the inactivation event has been detected (S901: YES), the inactivation event detector 41d notifies the reset control unit 25 in the VMM 21 of the result detecting the inactivation event. The reset control unit 25 of the VMM 21 updates the VM management table 4h (S902), and sets the status of the inactivation event detection information associated to the VM 41 to be “detected”.

The key input monitoring unit 24 of the VMM 21 determines whether the input of the reset key is accepted or not (S903). When having determined that the input of the reset key is not accepted (S903: NO), the key input monitoring unit 24 waits until that the input of the reset key is accepted. When the key input monitoring unit 24 has determined that the input of the reset key is accepted (S903: YES), the reset processing is started in the VMM 21 and in the management OS 31. The reset control unit 25 stops monitoring the key input and the I/O request (S904), and then the VM control unit 32 of the management OS 31 inactivates the VM 41 (S905). The reset control unit of the VMM 21 obtains the resource information from the VM management table 4h (S906), and the resources assigned to the VM 41 are released in the management OS 31 in accordance with the resource information (S907). When having received the completion notice of releasing assigned resources from the VM control unit 32, the reset control unit 25 updates the VM management table 4h (S908).

The reset control unit 25 of the VMM 21 determines whether the status is “detected” or not, in reference to the inactivation event detection information of the VM management table 4h (S909). In the case that the inactivation event detector 41d has detected the inactivation event, the status of the inactivation event detection information has been set to be “detected”. Therefore, the reset control unit 25 can determines, on the basis of the determination result whether the status is “detected” or “undetected”, whether the inactivation processing for the VM 41 is performed before the input of the reset key is accepted at S903.

When having determined that the status is not “detected”, i.e., that the status is “undetected” (S909: NO), the reset control unit 25 determines that the inactivation processing for the VM 41 is not performed before the input of the reset key is accepted. Therefore, the reset control unit 25 continues the reset processing that is started in response to the input of the reset key, and then activates the inactivated VM 41 (S910). Thus, the reset processing in response to the reset key input is completed.

When having determined that the status is “detected” (S909: NO), the reset control unit 25 determines that the inactivation processing for the VM 41 is performed before the input of the reset key is accepted. In that case, the reset control unit 25 terminates the reset processing at S905 where the VM 41 is inactivated. In that case, the VM 41 is not re-activated even when the input of the reset key is accepted, since it is considered that the VM 41 is hung (abnormally paused) during the inactivation processing due to some reasons.

As described above, it is possible in embodiment 6 to forcibly shut down the VM 41 (42, 43 or 44) in response to the input of the reset key, even in the case that malfunction is caused on the VM 41 (42, 43 or 44) during the inactivation processing and then the inactivation processing is interrupted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification related to a showing of the superiority and inferiority of the invention. Although the embodiments of the present inventions have been described in detail, it should be understood that the various changes, substitutions, and alternations could be made hereto without departing from the spirit and scope of the invention.

It will be described below about appendant according to additional embodiments.

### Appendant 1

An information processing apparatus comprising:
means for dividing physical resources logically and working the divided physical resources as a plurality of virtual machines;
a plurality of input and output means for inputting and outputting data;
assigning means for assigning any of the plurality of input and output means to any of the operating virtual machines;
transfer means for transferring data between the input and output means and the virtual machine assigned with the input and output means;
detecting means for detecting input of predetermined data from the input and output means;
inactivating means for inactivating any of the operating virtual machines when the detecting means detects; and
activating means for activating the inactivated virtual machine after the inactivating means inactivates.

### Appendant 2

An information processing apparatus according to appendant 1, wherein
when the detecting means detects, the inactivating means inactivates the virtual machine assigned with the input and output means from which the predetermined data is input.

### Appendant 3

An information apparatus according to appendant 1 or 2, wherein
when the predetermined data is input from the input and output means, the transfer means notifies the detecting means of the input,
the virtual machine comprises means for outputting signal periodically,
the information apparatus further comprises monitoring means for monitoring whether the signal is periodically output from the virtual machine or not,
when the signal is output from the virtual machine, the detecting means detects the input on the basis of notification received from the transfer means,
when the signal is not output from the virtual machine, the detecting means detects the input through obtaining, directly from the input and output means, the predetermined data input by the input and output means.

### Appendant 4

An information processing apparatus according to appendant 3, further comprising:
emulator means for implementing a pseudo function of a function provided with the input and output means, wherein
the emulator means outputs data input from the input and output means toward the transfer means, and outputs data input from the transfer means toward the input and output means.

### Appendant 5

An information processing apparatus according to appendant 3 or 4, wherein
the input and output means is a USB device that can be attached and detached,
the virtual machine comprises means for outputting, to the input and output means, request signal for communication connection in the case that the assigned input and output means is connected,
the input and output means outputs response signal for the request signal toward the virtual machine,
the virtual machine further comprises means for establishing communication connection to the input and output means in the case that the response signal is input from the input and output means,
the monitoring means monitors whether the request signal is periodically output from the virtual machine or not.

### Appendant 6

An information processing apparatus according to any one of appendants 1 to 5, further comprising:
setting means for setting predetermined data, wherein
the detecting means detects that the input and output means inputs the predetermined data set by the setting means.

### Appendant 7

An information processing apparatus according to any one of appendants 1 to 6, further comprising:
selection accepting means for accepting a selection of any one of plurality of operating virtual machines, when the detecting means detects that the predetermined data has been input, wherein
the detecting means detects that the input and output means inputs data corresponding to the virtual machine of the selection accepted by the selection accepting means, and
the inactivating means inactivates the virtual machine of the selection accepted by the selection accepting means, when the detecting means detects input.

### Appendant 8

An information processing apparatus according to any one of appendants 1 to 6, further comprising:
connecting means for connecting to a storage medium recording identification information for identifying the virtual machine; and
reading means for reading out the identification information from the storage medium when the storage medium is connected to the connecting means, wherein
the detecting means detects that the input and output means inputs data corresponding to the virtual machine identified by the identification information that is read out by the reading means,
the inactivating means inactivates the virtual machine identified by the identification information, when the detecting means has detected the input.

### Appendant 9

An information processing apparatus according to any one of appendants 1 to 8, further comprising:
inactivate instruction receiving means for receiving a inactivate instruction to inactivate a operating virtual machine; and
inhibiting means for inhibiting the activation performed by the activating means, when the inactivate instruction receiving means receives the inactivate instruction and the inactivate means inactivates the virtual machine.

### Appendant 10

An information processing apparatus according to any one of appendants 1 to 9, further comprising:
releasing means for releasing the assignment performed by the assigning means when the inactivating means inactivates the virtual machine; and
re-assigning means for assigning to the virtual machine the input and output means having been assigned by the assigning means before the inactivate performed by the inactivating means, when the activating means activates the virtual machine.

### Appendant 11

An information processing apparatus according to any one of appendants 1 to 10, further comprising:

informing means for informing of the inactivate, when the inactivating means starts inactivating the virtual machine.

### Appendant 12

An image processing method performed with an information processing apparatus having a plurality of input and output means for inputting and outputting data, dividing physical resources logically, and allowing the divided physical resources to work as a plurality of virtual machines, comprising:
assigning any of the input and output means to any of the operating virtual machines;
transferring data between the input and output means and the virtual machine assigned with the input and output means;
detecting input of predetermined data from the input and output means;
inactivating any of the operating virtual machines when the input is detected; and
activating the inactivated virtual machine.

### Appendant 13

A computer program with a computer dividing physical resources logically and working the divided physical resources as a plurality of virtual machines, comprising
allowing the computer to work as assigning means for assigning any of plural input and output means to any of the operating virtual machines, wherein the plural input and output means inputs and outputs data;
allowing the computer to work as transfer means for transferring data between the input and output means and the virtual machine assigned with the input and output means;
allowing the computer to work as detecting means for detecting input of predetermined data from the input and output means;
allowing the computer to work as inactivating means for inactivating any of the operating virtual machines when the detecting means detects; and
allowing the computer to work as activating means for activating the inactivated virtual machine after the inactivating means inactivates.

What is claimed is:

1. An information processing apparatus having a plurality of resources for performing as a plurality of virtual machines, each of which has a data input unit, comprising:
an assigning unit that assigns the plurality of resources to the plurality of virtual machines;
a storing unit that stores resource information indicating correspondences between the plurality of resources assigned by the assigning unit and the plurality of virtual machines;
a receiving unit that receives a reset instruction from each data input unit; and
a reset control unit that resets a predetermined virtual machine among the plurality of virtual machines in response to receiving the reset instruction by the reset instruction, wherein
when the reset control unit resets the predetermined virtual machine, the assigning unit re-assigns resources among the plurality of resources to the predetermined virtual machine, based on the resource information stored by the storing unit.

2. An information processing apparatus according to claim 1, wherein
the plurality of resources comprise a CPU, a RAM, a HDD, a plurality of monitor display devices and a plurality of input devices.

3. An information processing apparatus according to claim 1, wherein
the reset instruction comprises identification information for identifying a virtual machine to be reset among the plurality of virtual machines, and
the reset control unit resets the virtual machine identified by the identification information of the reset instruction that is received by the receiving unit.

4. An information processing apparatus according to claim 1, wherein
the plurality of virtual machines operate independently of one another.

5. An information processing apparatus according to claim 1, further comprising:
a determining unit that determines whether each virtual machine pauses abnormally or not; and
a monitoring unit that monitors data input from the data input unit of the virtual machine which is determined to pause abnormally by the determining unit, wherein
the receiving unit is allowed to receive the reset instruction from the data input unit monitored by the monitoring unit.

6. An information processing apparatus according to claim 1, further comprising:
a setting unit that sets an input manipulation for inputting the reset instruction from said each data input unit, wherein
the receiving unit is allowed to receive the reset instruction input with a manipulation identical to the input manipulation set by the setting unit.

7. An information processing apparatus according to claim 1, further comprising:
a plurality of connecting units respectively corresponding to the plurality of virtual machines, each of which connects with a storage medium, wherein
the receiving unit is allowed to receive the reset instruction input by the data input unit of the virtual machine that corresponds to a connecting unit to which the storage medium is connected.

8. An information processing apparatus according to claim 1, wherein
said each data input unit is detachable and attachable, and
the storing unit updates the stored resource information in response to attaching an input unit.

9. An information processing apparatus according to claim 2, wherein
when the reset control unit resets the predetermined virtual machine, a monitor display device assigned to the predetermined virtual machine displays a message for informing of reset.

10. An information processing apparatus according to claim 3, further comprising:
an acquiring unit that acquires an inactivation instruction from said each data input unit; and
an inactivation unit that inactivates a virtual machine indicated by the inactivation instruction which is acquired by the acquiring unit, wherein
in the case that the inactivation unit has inactivated the identified virtual machine with the reset instruction received by the receiving unit, the reset control unit does not reset the identified virtual machine, and
in the case that the inactivation unit has not inactivates the identified virtual machine with the reset instruction received by the receiving unit, the reset control unit resets the identified virtual machine.

11. An information processing method with an information processing apparatus that has a plurality of resources and performs as a plurality of virtual machines, each of which has a data input unit, comprising:
assigning the plurality of resources to the plurality of virtual machines;
storing resource information that indicates assigned correspondences between the plurality of resources and the plurality of virtual machines, onto a storing unit of the information processing apparatus;
receiving a reset instruction from the data input unit; and
resetting a predetermined virtual machine among the plurality of virtual machines in response to receiving the reset instruction, wherein
when the predetermined virtual machine is reset, resources among the plurality of resources are re-assigned to the predetermined virtual machine, based on the resource information stored on the storing unit.

12. An information processing method according to claim 11, further comprising:
preparing a CPU, a RAM, a HDD, a plurality of monitor display devices and a plurality of input devices, as the plurality of resources.

13. An information processing method according to claim 11, further comprising:
identifying a virtual machine indicated by the received reset instruction among the plurality of virtual machines, and
resets the identified virtual machine.

14. An information processing method according to claim 11, further comprising:
allowing the plurality of virtual machines operate independently of one another.

15. An information processing method according to claim 11, further comprising:
determining whether each virtual machine pauses abnormally or not; and
monitoring data input from the data input unit of the virtual machine which is determined to pause abnormally, wherein
it is allowed to receive the reset instruction from the monitored data input unit.

16. An information processing method according to claim 11, further comprising:
setting an input manipulation for inputting the reset instruction from each data input unit, wherein
it is allowed to receive the reset instruction input with a manipulation identical to the set input manipulation.

17. An information processing method according to claim 11, further comprising:
preparing on the information processing apparatus a plurality of connecting units, each of which connects to a storage medium;
corresponding the plurality of connecting units to the plurality of virtual machines, respectively; and
detecting whether each connecting unit is connected to the storage medium or not, wherein
it is allowed to receive the reset instruction input by the data input unit of the virtual machine that corresponds to the connecting unit on which connection of the storage medium is detected.

18. An information processing method according to claim 11, further comprising:
determining whether or not a change occurs on the data input unit between detachment and attachment, and
updating the resource information stored on the storing unit in response to determining that the change occurs.

19. An information processing method according to claim 12, further comprising:
displaying a message for informing of reset on a monitor display device assigned to the predetermined virtual machine, in the case of resetting the predetermined virtual machine.

20. An information processing method according to claim 13, further comprising:
acquiring an inactivation instruction from the data input unit; and
inactivating operation of a virtual machine indicated by the acquired inactivation instruction, wherein
in the case of having inactivated the virtual machine identified by the received reset instruction, it is not allowed to reset the identified virtual machine, and
in the case that having not inactivated the virtual machine identified by the received reset instruction, it is allowed to reset the identified virtual machine.
